(19) United States
(12) Patent Application Publication
(10) Pub. No.: US 2026/0017860 A1
(43) Pub. Date: Jan. 15, 2026

(54) ARTIFICIAL INTELLIGENCE-BASED IMAGE PROCESSING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Hui GUO, Shenzhen (CN)

(21) Appl. No.: 19/327,815

(22) Filed: Sep. 12, 2025

Related U.S. Application Data
(63) Continuation of application No. PCT/CN2024/105277, filed on Jul. 12, 2024.

(30) Foreign Application Priority Data
Aug. 3, 2023 (CN) 202310969776.3

(51) Int. Cl. G06T 11/60; G06T 5/50; G06T 5/60; G06T 5/70

(52) U.S. Cl. CPC G06T 11/60; G06T 5/50; G06T 5/60; G06T 5/70; G06T 2207/20081; G06T 2207/20084; G06T 2207/20221

(57) ABSTRACT

An artificial intelligence-based image processing method includes: performing noise addition on an object image to obtain a noisy image encoding vector; performing text encoding on an action instruction text to obtain a first action text encoding vector; denoising the noisy image encoding vector based on the first action text encoding vector to obtain a first action image; updating the first action text encoding vector based on a difference between the first action image and the object image to obtain a second action text encoding vector; performing fusion processing on the first action text encoding vector and the second action text encoding vector to obtain a fused action text encoding vector; and denoising the noisy image encoding vector based on the fused action text encoding vector to obtain a second action image.

### CROSS-REFERENCES TO RELATED APPLICATIONS

This application is a continuation of PCT Application No. PCT/CN2024/105277, filed on Jul. 12, 2024, which claims priority to Chinese Patent Application No. 202310969776.3 filed on Aug. 3, 2023, the entire contents of all of which are incorporated herein by reference.

### FIELD OF THE TECHNOLOGY

The present disclosure relates to the field of artificial intelligence technologies, and in particular, to an artificial intelligence-based image processing method and apparatus, an electronic device, and a computer-readable storage medium.

### BACKGROUND OF THE DISCLOSURE

Artificial intelligence (AI) is an integrated technology in computer science, which relates to studying design principles and implementation methods of various intelligent machines to enable the machines to have functions of perception, reasoning, and decision-making. The artificial intelligence technology is an interdisciplinary field that covers a wide range of areas, such as a natural language processing technology and machine learning/deep learning. With development of technologies, artificial intelligence is being applied to more fields and playing an increasingly important role.

An artificial intelligence-based image editing technology, especially an action editing technology for images, has been widely applied to an image creation process. However, although action editing can be implemented by using the action editing technology, it is difficult to keep the images consistent before and after editing, and this in turn undermines an image editing effect.

### SUMMARY

Embodiments of the present disclosure provide an artificial intelligence-based image processing method and apparatus, an electronic device, a computer-readable storage medium, and a computer program product, to implement action editing while retaining main content of an object image.

Technical solutions in embodiments of the present disclosure are implemented as follows.

An embodiment of the present disclosure provides an artificial intelligence-based image processing method, including: performing noise addition on an object image to obtain a noisy image encoding vector, and performing text encoding on an action instruction text to obtain a first action text encoding vector; denoising the noisy image encoding vector based on the first action text encoding vector to obtain a first action image, the denoising based on the first action text encoding vector being performed iteratively, a denoising result of a current round of the denoising being an input of a next round of the denoising, and the first action image being obtained by decoding a denoising result of a final round of the denoising; updating the first action text encoding vector based on a difference between the first action image and the object image to obtain a second action text encoding vector; performing fusion processing on the first action text encoding vector and the second action text encoding vector to obtain a fused action text encoding vector; and denoising the noisy image encoding vector based on the fused action text encoding vector to obtain a second action image, the second action image being a result of applying an action corresponding to the action instruction text to an object included in the object image.

An embodiment of the present disclosure provides an artificial intelligence-based image processing apparatus, including: an encoding module, configured to: perform noise addition on an object image to obtain a noisy image encoding vector, and perform text encoding on an action instruction text to obtain a first action text encoding vector; a fine-tuning module, configured to: denoise the noisy image encoding vector based on the first action text encoding vector to obtain a first action image, and update the first action text encoding vector based on a difference between the first action image and the object image to obtain a second action text encoding vector; a fusion module, configured to perform fusion processing on the first action text encoding vector and the second action text encoding vector to obtain a fused action text encoding vector; and a generation module, configured to denoise the noisy image encoding vector based on the fused action text encoding vector to obtain a second action image, the second action image being a result of applying an action corresponding to the action instruction text to an object included in the object image.

An embodiment of the present disclosure provides an artificial intelligence-based image processing method, including: obtaining an image editing request, the image editing request including any one of the following: an image rendering request or an action editing request; and invoking, when the image editing request is an image rendering request, an image rendering model to perform image rendering on an object image carried in the image editing request to obtain a rendered image; or invoking, when the image editing request is an action editing request, an action editing model to perform the method in embodiments of the present disclosure on an object image carried in the image editing request to obtain a second action image.

An embodiment of the present disclosure provides an artificial intelligence-based image processing method. The method is performed by an electronic device. The method includes: displaying an image editing entry; displaying, in response to an information input operation at the image editing entry, input image editing information, the image editing information including a basic image and editing information, the editing information including at least one of the following: an editing text and a guide image, the editing text being an action instruction text or a rendering text, and the guide image and the rendering text both representing a rendering direction; and displaying, in response to an image processing operation based on the image editing information, a target image obtained by editing the basic image based on the editing information.

An embodiment of the present disclosure provides an electronic device. The electronic device includes: a memory, configured to store computer-executable instructions; and a processor, configured to implement, when executing the computer-executable instructions stored in the memory, the artificial intelligence-based image processing method provided in embodiments of the present disclosure.

An embodiment of the present disclosure provides a non-transitory computer-readable storage medium, having computer-executable instructions stored thereon, the computer-executable instructions being configured for implementing, when executed by a processor, the artificial intelligence-based image processing method provided in embodiments of the present disclosure.

Embodiments of the present disclosure have the following beneficial effects:

In embodiments of the present disclosure, noise addition is performed on an object image to obtain a noisy image encoding vector, and text encoding is performed on an action instruction text to obtain a first action text encoding vector. The noisy image encoding vector is denoised based on the first action text encoding vector to obtain a first action image, and the first action text encoding vector is updated based on a difference between the first action image and the object image to obtain a second action text encoding vector. Herein, this is equivalent to performing fine-tuning on a representation of the action instruction text, to ensure cognition about an original object image in an image processing process and control consistency in an image editing process. Fusion processing is performed on the first action text encoding vector and the second action text encoding vector to obtain a fused action text encoding vector. The noisy image encoding vector is denoised based on the fused action text encoding vector to obtain a result of applying an action corresponding to the action instruction text to an object included in the object image. Because the result is generated based on control of the fused action text encoding vector, action editing can be implemented while ensuring image consistency.

### BRIEF DESCRIPTION OF THE DRAWINGS

FIG. 1 is a schematic diagram of a structure of an image processing system according to an embodiment of the present disclosure.

FIG. 2 is a schematic diagram of a structure of an electronic device according to an embodiment of the present disclosure.

FIG. 3A is a first schematic flowchart of an image processing method according to an embodiment of the present disclosure.

FIG. 3B is a second schematic flowchart of an image processing method according to an embodiment of the present disclosure.

FIG. 3C is a third schematic flowchart of an image processing method according to an embodiment of the present disclosure.

FIG. 3D is a fourth schematic flowchart of an image processing method according to an embodiment of the present disclosure.

FIG. 3E is a fifth schematic flowchart of an image processing method according to an embodiment of the present disclosure.

FIG. 4A is a first schematic diagram of an image creation interface.

FIG. 4B is a second schematic diagram of an image creation interface.

FIG. 5A is a schematic diagram of a first interface in an image processing method according to an embodiment of the present disclosure.

FIG. 5B is a schematic diagram of a second interface in an image processing method according to an embodiment of the present disclosure.

FIG. 5C is a schematic diagram of a third interface in an image processing method according to an embodiment of the present disclosure.

FIG. 5D is a schematic diagram of a fourth interface in an image processing method according to an embodiment of the present disclosure.

FIG. 5E is a schematic diagram of a fifth interface in an image processing method according to an embodiment of the present disclosure.

FIG. 5F is a schematic diagram of a sixth interface in an image processing method according to an embodiment of the present disclosure.

FIG. 6 is a schematic diagram of a system in an image processing method according to an embodiment of the present disclosure.

FIG. 7 is a schematic diagram of rendering in an image processing method according to an embodiment of the present disclosure.

FIG. 8 is a schematic diagram of action editing in an image processing method according to an embodiment of the present disclosure.

FIG. 9 is a schematic diagram of fine-tuning in an image processing method according to an embodiment of the present disclosure.

FIG. 10 is a schematic diagram of action editing in an image processing method according to an embodiment of the present disclosure.

### DESCRIPTION OF EMBODIMENTS

To make objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following descriptions, the term “some embodiments” describe a subset of all possible embodiments. However, the term “some embodiments” may be the same subset or different subsets of all possible embodiments, and may be combined with each other without conflict.

In the following descriptions, the term “first/second/third” is merely used for distinguishing similar objects and does not represent a specific order of objects. The term “first/second/third” may be interchanged with a specific order or priority if permitted, so that embodiments of the present disclosure described herein can be implemented in an order other than that illustrated or described herein.

Unless otherwise defined, meanings of all technical and scientific terms used in this specification are the same as those usually understood by a person skilled in the art to which the present disclosure belongs. The terms used in the specification are merely intended to describe the objectives of embodiments of the present disclosure, but are not intended to limit the present disclosure.

Before embodiments of the present disclosure are further described in detail, descriptions of terms in embodiments of the present disclosure are provided. The terms in embodiments of the present disclosure are applicable to the following explanations.

(1) Text-to-image diffusion model: The text-to-image diffusion model is a generation model based on a diffusion process. An input of the generation model is text. The generation model performs text-based image restoration on a random noisy image, to generate a prediction image related to the text.

(2) Image editing: The image editing includes a plurality of cases: style change, action editing, and scene time atmosphere rendering. The style change means performing image style transformation on an input image. The action editing means changing an action of an object in an image. The scene time atmosphere rendering means changing an entire image atmosphere, for example, changing an image of a sunny day to an image of a rainy day.

(3) Scene time atmosphere rendering is to perform operations such as time, four seasons, morning, and nighttime on a scene in an image. For example, the image is initially in a daytime atmosphere, and becomes a black-night atmosphere after rendering; and the image is initially in a spring atmosphere, and becomes an autumn atmosphere after rendering. Image content before and after rendering does not change, and only season-related content is changed.

(4) Image noise addition: The image noise addition is a process of artificially introducing noise to an image, and is a common image processing technology for simulating noise in the real world or improving an effect of image analysis in particular application. The noise addition may be for simulating various noise types, for example, Gaussian noise, salt and pepper noise, and uniform noise, to better research impact of noise on an image processing algorithm or train a denoising algorithm.

(5) Image denoising: The image denoising a process of eliminating or reducing noise from image data. Image noise may be random interference introduced by an image capture device, in a transmission process, or in a storage process, causing degradation of image quality and blurring of details. An objective of denoising is to restore definition of an image and reduce impact of noise on image quality, so that the image is more suitable for subsequent analysis and processing.

(6) Downsampling: The downsampling is processing of reducing a quantity of sampling points in image data and reducing resolution and a detail degree of an image, to reduce a data amount, reduce processing complexity, or reduce a storage requirement.

(7) Attention mechanism: The attention mechanism is a process in which different degrees of attention are given when each piece of input data is processed. Attention processing is a process of screening data or information and focusing attention on data or information in the fields of computer vision and natural language processing. This process usually includes performing classification, clustering, or association analysis on input data or information, to find key information or features.

In the field of image editing, although object action editing might be implemented, an action editing solution may not ensure image consistency before and after editing when action editing is implemented.

Embodiments of the present disclosure provide an image processing method and apparatus, an electronic device, a computer-readable storage medium, and a computer program product, to implement action editing while retaining main content of an object image.

The following describes exemplary applications of the electronic device provided in embodiments of the present disclosure. The electronic device provided in embodiments of the present disclosure may be implemented as a terminal or a server.

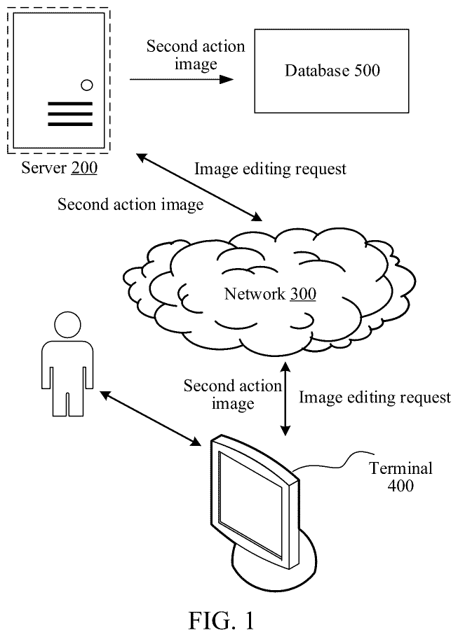

FIG. 1 is a schematic diagram of an application mode of an image processing method according to an embodiment of the present disclosure. For example, in FIG. 1, a server 200, a network 300, and a terminal 400 are included. The terminal 400 is connected to the server 200 via the network 300. The network 300 may be a wide area network, a local area network, or a combination of the two.

In some embodiments, the server 200 may be a server corresponding to an application. For example, the application is image processing software installed in the terminal 400, and the server 200 is an image processing background configured to perform the image processing method provided in embodiments of the present disclosure.

In some embodiments, the terminal 400 receives an image editing request. The image editing request herein carries an image uploaded by a user and an action instruction text. The terminal 400 transmits the image editing request to the server 200. The server 200 performs noise addition on an object image to obtain a noisy image encoding vector, performs text encoding on the action instruction text to obtain a first action text encoding vector, denoises the noisy image encoding vector based on the first action text encoding vector to obtain a first action image, updates the first action text encoding vector based on a difference between the first action image and the object image to obtain a second action text encoding vector, perform fusion processing on the first action text encoding vector and the second action text encoding vector to obtain a fused action text encoding vector, denoises the noisy image encoding vector based on the fused action text encoding vector to obtain a second action image that is obtained by applying an action corresponding to the action instruction text to the object image, and returns the second action image to the terminal 400.

In some embodiments, the server 200 may be an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The terminal 400 may be a smartphone, a tablet computer, a notebook computer, a desktop computer, a smart speaker, a smartwatch, a smart television, a vehicle-mounted terminal, or the like, but is not limited thereto. The terminal and the server may be connected directly or indirectly in a wired or wireless communication manner, which is not limited in embodiments of the present disclosure. A database 500 may be separately disposed and may be integrated on the server 200, or the database 500 may be disposed on a machine independent of the server 200, which is not limited in this embodiment of the present disclosure. The database 500 provided in this embodiment of the present disclosure may be configured to store the second action image generated by the server 200 for remote storage and backup.

In some embodiments, the terminal 400 may implement the image processing method provided in embodiments of the present disclosure by running a computer program. For example, the computer program may be a native program or a software module in an operating system. The computer program may be a native application (APP), that is, a program that needs to be installed in the operating system to run, for example, a camera APP. The computer program may alternatively be a mini program, to be specific, a program that only needs to be downloaded into a browser environment to run. The computer program may further be a mini program that can be embedded in any APP. In summary, the foregoing computer program may be an application, a module, or a plug-in in any form.

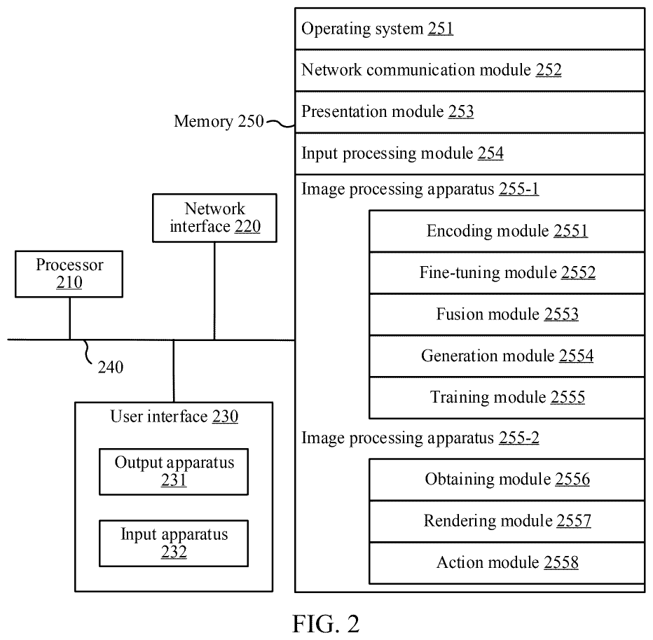

FIG. 2 is a schematic diagram of a structure of an electronic device according to an embodiment of the present disclosure. The electronic device may be a terminal or a server. An example in which the electronic device is a server is used for description. The server shown in FIG. 2 includes at least one processor 210, a memory 250, at least one network interface 220, and a user interface 230. Components in the terminal 400 are coupled together via a bus system 240. The bus system 240 is configured to implement connection and communication between the components. In addition to a data bus, the bus system 240 further includes a power bus, a control bus, and a state signal bus. However, for clear description, various buses in FIG. 2 are denoted as the bus system 240.

The processor 210 may be an integrated circuit chip having a signal processing capability, for example, a general-purpose processor, a digital signal processor (DSP), another programmable logic device, a discrete gate or transistor logic device, or a discrete hardware component. The general-purpose processor may be a microprocessor, any routine processor, or the like.

The user interface 230 includes one or more output apparatuses 231 that can present medium content and that include one or more speakers and/or one or more visual display screens. The user interface 230 further includes one or more input apparatuses 232 that may include a user interface component that facilitate user input, for example, a keyboard, a mouse, a microphone, a touchscreen display screen, a camera, and another input button and control.

The memory 250 may be a removable memory, a non-removable memory, or a combination thereof. An exemplary hardware device includes a solid-state memory, a hard disk drive, an optical disk drive, and the like. In some embodiments, the memory 250 includes one or more storage devices physically located away from the processor 210.

The memory 250 includes a volatile memory or a non-volatile memory, or may include both a volatile memory and a non-volatile memory. The non-volatile memory may be a read-only memory (ROM), and the volatile memory may be a random access memory (RAM). The memory 250 described in this embodiment of the present disclosure is intended to include any suitable type of memories.

In some embodiments, the memory 250 can store data to support various operations. Examples of the data include a program, a module, and a data structure, or a subset or a superset thereof. Descriptions are provided below by using examples.

An operating system 251 includes a system program configured for processing various basic system services and performing hardware-related tasks, for example, a framework layer, a core library layer, and a drive layer, and is configured to implement various basic services and process hardware-based tasks.

A network communication module 252 is configured to reach another electronic device via one or more (wired or wireless) network interfaces 220. For example, the network interface 220 includes Bluetooth, wireless compatibility certification (Wi-Fi), a universal serial bus (USB), and the like.

A presentation module 253 is configured to present information by the one or more output apparatuses 231 (for example, a display screen and a speaker) associated with the user interface 230 (for example, a user interface configured for operating a peripheral device and display content and information).

An input processing module 254 is configured to detect one or more user inputs or interactions from one of the one or more input apparatuses 232 and translate the detected input or interaction.

In some embodiments, the image processing apparatus provided in embodiments of the present disclosure may be implemented in a software manner. FIG. 2 shows an image processing apparatus 255-1 stored in the memory 250. The image processing apparatus 255-1 may be software in the form of a program and a plug-in, and the like, and includes the following software modules: an encoding module 2551, a fine-tuning module 2552, a fusion module 2553, a generation module 2554, and a training module 2555. FIG. 2 shows an image processing apparatus 255-2 stored in the memory 250. The image processing apparatus 255-2 may be software in the form of a program and a plug-in, and the like, and includes the following software modules: an obtaining module 2556, a rendering module 2557, and an action module 2558. These modules are logical, so that the modules can be arbitrarily combined or further split based on achieved functions. The functions of the modules are described below.

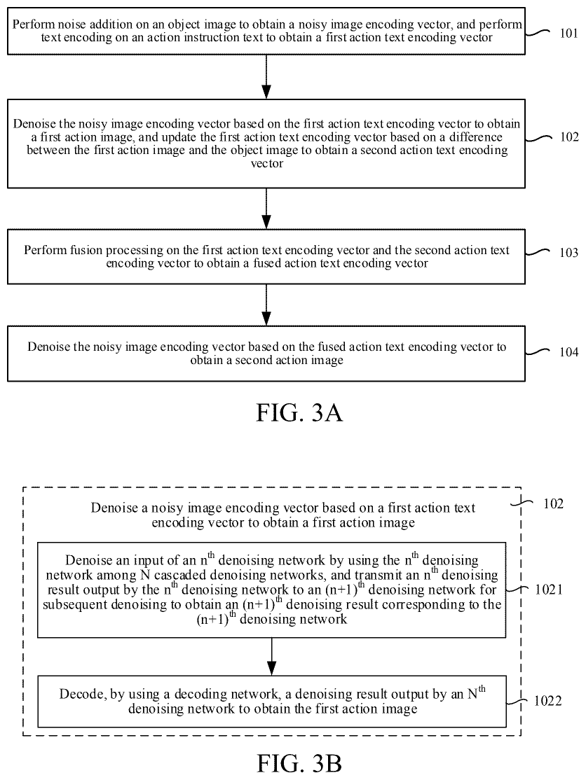

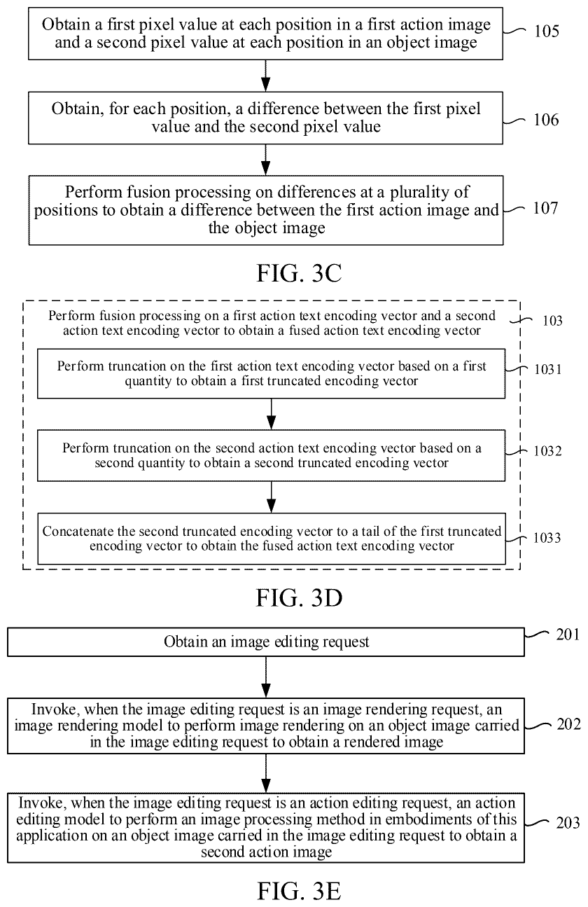

The image processing method provided in embodiments of the present disclosure is described below. As mentioned above, the electronic device that implements the image processing method provided in embodiments of the present disclosure may be a terminal or a server. An example in which the electronic device is a server is used for description. Therefore, an execution entity of each operation is not repeatedly described below. Refer to FIG. 3A. Descriptions are provided with reference to operation 101 to operation 104 shown in FIG. 3A.

Operation 101: Perform noise addition on an object image to obtain a noisy image encoding vector, and perform text encoding on an action instruction text to obtain a first action text encoding vector.

In an example, the object image may be an image uploaded by a user or may be obtained through photographing. An object may be a human being, an animal, a physical object, or a virtual object. The object image herein may be an image including a human being and an animal, or may be an image including an item. The action instruction text herein includes a basic image description and a user-editable action text. The basic image description is a text for describing the object image, for example, “man” and “woman”. The user-editable action text is an action that is of the object in the image and that the user expects to present, for example, “smile” and “hand raising”. The physical object is, for example, an object in the real world. The virtual object is, for example, a virtual prop in a virtual game scene or a virtual object in a painting work.

In some embodiments, the performing noise addition on an object image to obtain a noisy image encoding vector in operation 101 may be implemented through the following technical solutions: superimposing the object image and a noisy image to obtain a superimposed image; and performing image latent space encoding on the superimposed image to obtain the noisy image encoding vector. The image latent space encoding may be implemented in the following method: inputting the superimposed image into an image encoder of a text-image contrastive model, and representing the superimposed image by using a feature vector of an intermediate hidden layer of the image encoder to obtain the noisy image encoding vector.

In this embodiment of the present disclosure, the latent space encoding is performed, so that subsequent denoising can be performed in latent space, to reduce a calculation amount and improve a denoising effect.

In an example, a seed i is randomly selected to generate a noisy image, the generated noisy image and an original object image are superimposed to generate a superimposed image x, and latent space encoding is performed on the superimposed image x to obtain a noisy image encoding vector Z_{T} as a latent space representation. The seed i in a noise generation algorithm is a parameter used as an initial value of a random number generator. The latent space encoding is to invoke an encoder to map image data of the superimposed image x from a high dimension to latent space in a low dimension.

In some embodiments, the text encoding is implemented by invoking a text model in the text-image contrastive model. A plurality of first text samples and first image samples respectively matching the first text samples are obtained. Image encoding is performed on each first image sample by using a visual model of the text-image contrastive model to obtain an image encoding vector of each first image sample. Text encoding is performed on each first text sample by using the text model of the text-image contrastive model to obtain a text encoding vector of each first text sample. A text-image contrastive loss is determined based on the text encoding vector of each first text sample, the image encoding vector of each first image sample, and a matching relationship between each first text sample and each first image sample. A parameter of the text-image contrastive model is updated based on the text-image contrastive loss. In this embodiment of the present disclosure, alignment of the visual model and the text model in semantic space may be restricted, to improve a representation capability of the first action text encoding vector.

In an example, the first image sample matching the first text sample is an image including a picture corresponding to content described by the first text sample. A core idea of the text-image contrastive model is to train a visual-language model based on a semantic similarity between the first image sample and the first text sample. Specifically, the text-image contrastive model uses a neural network having a two-tower structure, where one tower is an image encoder, and the other tower is a text encoder. The image encoder is responsible for converting an image into a vector representation (an image encoding vector), and the text encoder is responsible for converting a text into a vector representation (a text encoding vector). Then, the text-image contrastive model optimizes an inner product between the two vectors by using a contrastive loss function. To be specific, the text-image contrastive model expects that a larger inner product between an image and a text indicates a higher similarity between the image and the text. On the contrary, a smaller inner product between the image and the text indicates a lower similarity between the image and the text.

Operation 102: Denoise the noisy image encoding vector based on the first action text encoding vector to obtain a first action image, and update the first action text encoding vector based on a difference between the first action image and the object image to obtain a second action text encoding vector.

For example, the denoising performed on the noisy image encoding vector based on the first action text encoding vector includes a denoising operation and a decoding operation, and includes the following processing: inputting the first action text encoding vector and the noisy image encoding vector into a denoising network of a plurality of layers, recognizing and removing noise in the noisy image encoding vector by using the first action text encoding vector as a reference, and decoding the denoised noisy image encoding vector to obtain the first action image.

In some embodiments, the denoising based on the first action text encoding vector is implemented by using an image generation model. The image generation model includes N cascaded denoising networks and a decoding network, and a value range of N is 2≤N. Refer to FIG. 3B. The denoising the noisy image encoding vector based on the first action text encoding vector to obtain a first action image in operation 102 may be implemented through operation 1021 and operation 1022 shown in FIG. 3B.

Operation 1021: Denoise an input of an n^{th} denoising network by using the n^{th} denoising network among the N cascaded denoising networks, and transmit an n^{th} denoising result output by the n^{th} denoising network to an (n+1)^{th} denoising network for subsequent denoising to obtain an (n+1)^{th} denoising result corresponding to the (n+1)^{th} denoising network.

For example, the denoising performed by the N cascaded denoising networks is sequentially performed by the plurality of denoising networks, and an output of each denoising network (e.g., a current round of denoising using a current denoising network) is an input of a next denoising network (e.g., a next round of denoising using the next denoising network), that is, the denoising is performed iteratively.

Operation 1022: Decode, by using the decoding network, a denoising result output by an N^{th} denoising network to obtain the first action image.

In an example, the image generation model includes the N cascaded denoising networks and the decoding network, and it is equivalent to that denoising is performed for N times (e.g., the N^{th} denoising network is used in a final round of the denoising) and image decoding is finally performed. Each time denoising is performed based on a latent space image encoding vector obtained through previous denoising, and then the latent space image encoding vector is input to a next denoising network for denoising. n is an integer variable whose value increases incrementally starting from 1, a value range of n is 1≤n<N, when the value of n is 1, the input of the n^{th} denoising network is the noisy image encoding vector and the first action text encoding vector, and when the value range of n is 2≤n<N, the input of the n^{th} denoising network is an (n−1)^{th} denoising result output by an (n−1)^{th} denoising network and the first action text encoding vector.

An example in which N is 3 is used for description. The noisy image encoding vector (latent space noise encoding) and the first action text encoding vector are denoised by using a 1^{st} denoising network to obtain a 1^{st} denoising result. The 1^{st} denoising result and the first action text encoding vector are denoised by using a 2^{nd} denoising network to obtain a 2^{nd} denoising result. The 2^{nd} denoising result and the first action text encoding vector are denoised by using a 3^{rd} denoising network to obtain a 3^{rd} denoising result. Each denoising result obtained in the foregoing method is latent space encoding. The denoising performed by each denoising network is equivalent to denoising of one time step.

In some embodiments, the denoising an input of an n^{th} denoising network by using the n^{th} denoising network among the N cascaded denoising networks in operation 1021 may be implemented through the following technical solutions: performing first attention processing on an input of an m^{th} attention layer and the first action text encoding vector by using the m^{th} attention layer in the n^{th} denoising network to obtain a first attention feature as an m^{th} attention result of the m^{th} attention layer in the n^{th} denoising network; transmitting the m^{th} attention result of the m^{th} attention layer in the n^{th} denoising network to an (m+1)th attention layer for subsequent attention processing to obtain an (m+1)th attention result of the (m+1)th attention layer in the n^{th} denoising network; and using an M^{th} attention result output by an M^{th} attention layer in the n^{th} denoising network as the n^{th} denoising result.

In an example, a value range of M is 2≤M, m is an integer variable whose value increases incrementally starting from 1, a value range of m is 1≤m≤M−1, when the value of m is 1, the input of the m^{th} attention layer is the (n−1)^{th} denoising result, and when the value range of m is 2≤m<M, the input of the m^{th} attention layer is an (m−1)^{th} attention result output by an (m−1)^{th} attention layer.

In an example, the n^{th} denoising network includes H cascaded downsampling networks and H cascaded upsampling networks. A value of M herein is 2*H, and a value range of His 2≤H. The denoising an input of an n^{th} denoising network by using the n^{th} denoising network among the N cascaded denoising networks may be implemented through the following technical solutions: performing downsampling on the n^{th} denoising result and the first action text encoding vector by using the H cascaded downsampling networks to obtain a downsampling result of the n^{th} denoising network; and performing upsampling on the downsampling result of the n^{th} denoising network by using the H cascaded upsampling networks to obtain an upsampling result of the n^{th} denoising network as the n^{th} denoising result corresponding to the n^{th} denoising network. Downsampling and upsampling are performed in each denoising process, so that more detailed information can be retained in the denoising process.

Following the foregoing example, the 2^{nd} denoising network is used as an example for description. The denoising network may include three downsampling networks and three upsampling networks. Downsampling is performed on the 1^{st} denoising result and the first action text encoding vector by using the three cascaded downsampling networks to obtain a downsampling result of the 2^{nd} denoising network. Upsampling is performed on the downsampling result of the 2^{nd} denoising network by using the three cascaded upsampling networks to obtain an upsampling result of the 2^{nd} denoising network as the 2^{nd} denoising result corresponding to the 2^{nd} denoising network.

In an example, the performing downsampling on the n^{th} denoising result and the first action text encoding vector by using the H cascaded downsampling networks to obtain a downsampling result of the n^{th} denoising network may be implemented through the following technical solutions: performing downsampling on an input of an h^{th} downsampling network by using the h^{th} downsampling network among the H cascaded downsampling networks to obtain an h^{th} downsampling result corresponding to the h^{th} downsampling network; transmitting the h^{th} downsampling result corresponding to the h^{th} downsampling network to an (h+1)^{th} downsampling network for subsequent downsampling to obtain an (h+1)^{th} downsampling result corresponding to the (h+1)^{th} downsampling network; and using a downsampling result output by an H^{th} downsampling network as the n^{th} denoising result. h is an integer variable whose value increases incrementally starting from 1, a value range of h is 1≤h≤H−1, when the value of h is 1, the input of the h^{th} downsampling network is the (n−1)^{th} denoising result and the first action text encoding vector, and when the value range of h is 2≤h<H, the input of the h^{th} downsampling network is an (h−1)^{th} downsampling result output by an (h−1)^{th} downsampling network and the first action text encoding vector. A processing process of the upsampling network is the same as a processing process of the downsampling network.

Following the foregoing example, downsampling is performed on an input of a 1^{st} downsampling network by using the 1^{st} downsampling network to obtain a downsampling result corresponding to the 1^{st} downsampling network, and the downsampling result corresponding to the 1^{st} downsampling network is transmitted to a 2^{nd} downsampling network for subsequent downsampling to obtain a 2^{nd} downsampling result corresponding to the 2^{nd} downsampling network. Downsampling is performed on an input of the 2^{nd} downsampling network by using the 2^{nd} downsampling network to obtain a downsampling result corresponding to the 2^{nd} downsampling network, the downsampling result corresponding to the 2^{nd} downsampling network is transmitted to a 3^{rd} downsampling network for subsequent downsampling to obtain a 3^{rd} downsampling result corresponding to the 3^{rd} downsampling network, and the 3^{rd} downsampling result output by the 3^{rd} downsampling network is used as the 2^{nd} denoising result. Herein, the input of each downsampling network includes the first action text encoding vector.

In an example, an m^{th} downsampling network includes an attention layer. Performing downsampling on an input of the m^{th} downsampling network by using the m^{th} downsampling network among M cascaded downsampling networks to obtain an m^{th} downsampling result corresponding to the m^{th} downsampling network may be implemented through the following technical solution: performing first attention processing on an (m−1)^{th} downsampling result corresponding to an (m−1)^{th} downsampling network and the first action text encoding vector by using the attention layer to obtain the m^{th} downsampling result corresponding to the m^{th} downsampling network. Each downsampling network includes an attention layer. An input of the attention layer is an output of a previous cascaded downsampling network (that is, an output of an attention layer included in the previous cascaded downsampling network). In this embodiment of the present disclosure, more effective information may be retained by using a residual layer, and a space dimension may be modeled by using the attention layer based on a text encoding vector, to improve a denoising effect.

In some embodiments, the n^{th} denoising network includes M cascaded attention layers. The performing first attention processing on an input of an m^{th} attention layer and the first action text encoding vector by using the m^{th} attention layer in the n^{th} denoising network to obtain a first attention feature as an m^{th} attention result of the m^{th} attention layer in the n^{th} denoising network may be implemented through the following technical solutions: performing query matrix-based mapping on the input of the m^{th} attention layer to obtain an attention query matrix; performing key matrix-based mapping on the first action text encoding vector to obtain an attention key matrix; performing value matrix-based mapping on the first action text encoding vector to obtain an attention value matrix; multiplying the attention query matrix by a transpose matrix of the attention key matrix to obtain a multiplication result, and obtaining a ratio of the multiplication result to a dimension of the attention key matrix; and performing maximum likelihood processing on the ratio, and multiplying a maximum likelihood result by the attention value matrix to obtain the first attention feature.

Maximum likelihood estimation (MLE) is a statistical estimation method for parameter estimation such that, given observation data, a probability (that is, a likelihood) of a model is maximized. In this embodiment of the present disclosure, the maximum likelihood processing is to estimate a maximum value of the ratio of the result of multiplying the attention query matrix by the transpose matrix of the attention key matrix to the dimension of the attention key matrix and use the estimated maximum ratio as the maximum likelihood result.

In this embodiment of the present disclosure, the action instruction text may be integrated into the denoising network in a targeted manner, to restrict image generation, so as to improve a model training effect.

In an example, the first action text encoding vector used as a condition signal is introduced according to a cross-attention mechanism. In the cross-attention mechanism, condition information of the action instruction text may further be integrated into a denoising process. Refer to Formula (1) to Formula (3):

$$Q = {W}_{Q}^{( i )} \cdot z ; \qquad ( 1 )$$

$$K = {W}_{K}^{( i )} \cdot x ; and \qquad ( 2 )$$

$$V = {W}_{V}^{( i )} \cdot x . \qquad ( 3 )$$

z represents an output of the (m−1)^{th} attention layer.

$${W}_{V}^{( i )} , {W}_{Q}^{( i )} , and {W}_{K}^{( i )}$$

are projection matrices each having a learnable parameter.

$${W}_{V}^{( i )}$$

is the attention value matrix.

$${W}_{Q}^{( i )}$$

is an attention key matrix.

$${W}_{K}^{( i )}$$

is the attention query matrix. x is the first action text encoding vector. Q is the attention query matrix. K is the attention key matrix. V is the attention value matrix.

In some embodiments, refer to FIG. 3C. Before the updating the first action text encoding vector based on a difference between the first action image and the object image to obtain a second action text encoding vector in operation 102, operation 105 to operation 107 shown in FIG. 3C may be performed.

Operation 105: Obtain a first pixel value at each position in the first action image and a second pixel value at each position in the object image.

Herein, the first pixel value and the second pixel value are configured for distinguishing pixel values belonging to different images.

Operation 106: Obtain, for each position, a difference between the first pixel value and the second pixel value.

For example, for the same position in the first action image and in the object image, a difference between pixel values respectively corresponding to the position in the first action image and the object image is obtained. The difference between the two pixel values may be a square of the difference between the two pixel values. For example, a first pixel value at a position i in the first action image is

$${y}_{i}^{p} ,$$

a second pixel value at a position i in the object image is yᵢ, and a difference between the two pixel values is represented as

$${( {y}_{i} - {y}_{i}^{p} )}^{2} .$$

Operation 107: Perform fusion processing on differences at a plurality of positions to obtain the difference between the first action image and the object image.

In an example, refer to Formula (4):

$$M S E = {\sum }_{i = 1}^{n} {( {y}_{i} - {y}_{i}^{p} )}^{2} . \qquad ( 4 )$$

yᵢ is the second pixel value at the position i in the object image.

$${y}_{i}^{p}$$

is the first pixel value at the position i in the first action image. MSE is the difference between the first action image and the object image.

In this embodiment of the present disclosure, image consistency before and after processing is restricted, to ensure that main content of an image remains unchanged in an action editing process, so as to optimize an action editing effect of the image.

In some embodiments, the denoising based on the first action text encoding vector is implemented by using the image generation model. When the first action text encoding vector is updated based on the difference between the first action image and the object image, a parameter of the image generation model is updated based on the difference between the first action image and the object image to obtain an updated image generation model.

In an example, only the first action text encoding vector may be updated based on a difference, or both the first action text encoding vector and the image generation model may be updated based on the difference (where all parameters in the image generation model may be updated herein, or a parameter of a U-shaped network in the image generation model may be updated). In this embodiment of the present disclosure, when the first action text encoding vector is fine-tuned, the image generation model used for performing denoising may also be fine-tuned, to optimize a denoising effect.

Operation 103: Perform fusion processing on the first action text encoding vector and the second action text encoding vector to obtain a fused action text encoding vector.

In some embodiments, the performing fusion processing on the first action text encoding vector and the second action text encoding vector to obtain a fused action text encoding vector in operation 103 may be implemented through operation 1031 to operation 1033 shown in FIG. 3D.

Operation 1031: Perform truncation on the first action text encoding vector based on a first quantity to obtain a first truncated encoding vector, the first truncated encoding vector including a first quantity of vectors from the beginning of the first action text encoding vector.

For example, the first quantity may be set according to an actual application scenario. The truncation is to extract at least a part of content in an encoding vector.

Operation 1032: Perform truncation on the second action text encoding vector based on a second quantity to obtain a second truncated encoding vector, the second truncated encoding vector including a second quantity of vectors from the beginning of the second action text encoding vector.

For example, the second quantity may be set according to an actual application scenario. The first quantity and the second quantity may be the same or different.

Operation 1033: Concatenate the second truncated encoding vector to a tail of the first truncated encoding vector to obtain the fused action text encoding vector. That is, the second truncated encoding vector is appended to an end of the first truncated encoding vector to obtain the fused action text encoding vector.

In an example, a fine-tuned second action text encoding vector and the first action text encoding vector that is not fine-tuned are first concatenated to generate a final fused action text encoding vector. A concatenating principle is: The first action text encoding vector that is not fine-tuned is following by the fine-tuned second action text encoding vector, and a half of the first action text encoding vector that is not fine-tuned and a half of the fine-tuned second action text encoding vector are concatenated into the final fused action text encoding vector. For example, if 77 vectors are used for encoding in a diffusion model, the first 38 (a first quantity) vectors of the first action text encoding vector that is not fine-tuned and the first 39 (a second quantity) vectors of the fine-tuned second action text encoding vector are concatenated. Herein, the first action text encoding vector that is not fine-tuned needs to be placed at the front. The first action text encoding vector that is not fine-tuned retains more editing capabilities, the fine-tuned second action text encoding vector represents an original object image, and the object image cannot provide editing control information. Therefore, the first action text encoding vector that is not fine-tuned needs to be placed at the front to ensure a higher editing capability.

Operation 104: Denoise the noisy image encoding vector based on the fused action text encoding vector to obtain a second action image, the second action image being a result of applying an action corresponding to the action instruction text to an object included in the object image.

In some embodiments, the denoising based on the fused action text encoding vector herein and the denoising based on the first action text encoding vector in operation 102 may be performed by using completely the same model, to be specific, are both performed by using a pre-trained image generation model. Alternatively, the denoising based on the fused action text encoding vector herein and the denoising based on the first action text encoding vector in operation 102 may be performed by using models having a same structure and different parameters. To be specific, operation 104 is performed by using the image generation model obtained through the updating based on the difference, and operation 102 is performed only by using a pre-trained image generation model. Alternatively, the denoising based on the fused action text encoding vector herein and the denoising based on the first action text encoding vector in operation 102 may be performed by using action editing models having related but different structures. The action editing model includes an image generation model (which is obtained through the updating based on the difference in operation 102 or is a pre-trained image generation model used in operation 102) and a plurality of image information networks.

In some embodiments, the denoising based on the first action text encoding vector is implemented by using the image generation model, the denoising based on the fused action text encoding vector is implemented by using an action editing model, and the action editing model includes the image generation model and a plurality of image information networks. Before the denoising the noisy image encoding vector based on the fused action text encoding vector to obtain a second action image, forward propagation is performed in the action editing model on the noisy image encoding vector and an action text encoding vector to obtain a third action image, the action text encoding vector being the first action text encoding vector or the fused action text encoding vector. The plurality of image information networks in the action editing model are updated based on a difference between the third action image and the object image to obtain an updated action editing model.

In an example, the action editing model is formed by the image generation model and the plurality of cascaded image information networks. The action editing model may be trained before operation 104 is performed. In a training process, only the plurality of image information networks may be updated, and the parameter of the image generation model remains unchanged. The image generation model herein may be an image generation model obtained through the updating based on the difference obtained in operation 102.

In an example, the image generation model included in the action editing model may alternatively be an image generation model obtained through pre-training. In other words, the image generation model is not updated based on the difference obtained in operation 102. In this case, training for the action editing model may be performed before the model is deployed on a serving end, to be specific, the updating in operation 102 occurs after an image editing request of a user is received. In addition, the training for the action editing model may be performed after the image editing request of the user is received (after the action text encoding vector is updated based on the difference obtained in operation 102) or may be performed before the image editing request of the user is received.

In some embodiments, the image generation model includes N cascaded denoising networks and a decoding network, a value range of N is 2≤N, the action editing model is obtained by configuring, based on the image generation model, an image information network for each denoising network, each denoising network and the corresponding image information network form a fusion denoising network, and a cascade relationship between a plurality of fusion denoising networks is the same as a cascade relationship between the plurality of denoising networks. The forward propagation is performed in the action editing model on the noisy image encoding vector and an action text encoding vector to obtain a third action image may be implemented through the following technical solutions: performing fusion denoising on an input of an n^{th} fusion denoising network by using the n^{th} fusion denoising network among N cascaded fusion denoising networks, and transmitting an n^{th} fusion denoising result output by the n^{th} fusion denoising network to an (n+1)^{th} fusion denoising network for subsequent fusion denoising to obtain an (n+1)^{th} fusion denoising result corresponding to the (n+1)^{th} fusion denoising network; and decoding a fusion denoising result output by an N^{th} fusion denoising network to obtain the third action image.

In an example, n is an integer variable whose value increases incrementally starting from 1, a value range of n is 1≤n<N, when the value of n is 1, the input of the n^{th} fusion denoising network is the noisy image encoding vector and the action text encoding vector, and when the value range of n is 2n<N, the input of the n^{th} fusion denoising network is an (n−1)^{th} fusion denoising result output by an (n−1)^{th} fusion denoising network and the action text encoding vector.

In an example, the image generation model includes N cascaded fusion denoising networks and a decoding network, and it is equivalent to that fusion denoising is performed for N times and image decoding is finally performed. Each time denoising is performed based on a latent space image encoding vector obtained through previous denoising, and then the latent space image encoding vector is input to a next fusion denoising network for denoising. n is an integer variable whose value increases incrementally starting from 1, a value range of n is 1≤n<N, when the value of n is 1, the input of the n^{th} fusion denoising network is the noisy image encoding vector and the action text encoding vector, and when the value range of n is 2≤n<N, the input of the n^{th} fusion denoising network is an (n−1)^{th} fusion denoising result output by an (n−1)^{th} fusion denoising network and the first action text encoding vector.

An example in which N is 3 is used for description. Fusion denoising is performed on the noisy image encoding vector (latent space noise encoding) and the action text encoding vector by using a 1^{st} fusion denoising network to obtain a 1^{st} fusion denoising result. Fusion denoising is performed on the 1^{st} fusion denoising result and the action text encoding vector by using a 2^{nd} fusion denoising network to obtain a 2^{nd} fusion denoising result. Fusion denoising is performed on the 2^{nd} fusion denoising result and the action text encoding vector by using a 3^{rd} fusion denoising network to obtain a 3^{rd} fusion denoising result. Each fusion denoising result obtained in the foregoing method is latent space encoding. The fusion denoising performed by each fusion denoising network is equivalent to fusion denoising of one time step.

In some embodiments, the n^{th} fusion denoising network includes a plurality of downsampling networks, a plurality of upsampling networks, and an n^{th} image information network corresponding to the n^{th} denoising network. The performing fusion denoising on an input of an n^{th} fusion denoising network by using the n^{th} fusion denoising network among N cascaded fusion denoising networks may be implemented through the following technical solutions: performing bypass control on the noisy image encoding vector and the action text encoding vector by using the n^{th} image information network to obtain a bypass control result; performing downsampling on the action text encoding vector and the bypass control result by using the downsampling network to obtain a downsampling result; and performing upsampling on the downsampling result by using the upsampling network to obtain the n^{th} fusion denoising result. In this embodiment of the present disclosure, bypass control may be introduced, so that the overall action editing model is fine-tuned through the bypass control, to avoid computing resources consumed for updating the overall model.

In some embodiments, the n^{th} image information network includes P cascaded attention layers, and a value range of P is 2≤P. The performing bypass control on the noisy image encoding vector and the action text encoding vector by using the n^{th} image information network to obtain a bypass control result may be implemented through the following technical solutions: transmitting a p^{th} attention result of a p^{th} attention layer in the n^{th} image information network to a (p+1)^{th} attention layer for subsequent second attention processing to obtain a (p+1)^{th} attention result of the (p+1)^{th} attention layer in the n^{th} image information network; and using a second attention result output by each attention layer as the bypass control result. A structure of the n^{th} image information network is the same as that of the n^{th} fusion denoising network, so that fine-tuning of the overall action editing model can be implemented through fine-tuning of a parameter of the n^{th} image information network.

In an example, p is an integer variable whose value increases incrementally starting from 1, a value range of p is 1≤p<P−1, when the value of p is 1, an input of the p^{th} attention layer is the (n−1)^{th} fusion denoising result, and when the value range of p is 2≤p<P, the input of the p^{th} attention layer is a (p−1)^{th} attention result output by a (p−1)^{th} attention layer in the n^{th} image information network.

In an example, an input of each attention layer is an output of a previous cascaded attention layer. Performing the second attention processing on the input of the p^{th} attention layer and the action text encoding vector by using the p^{th} attention layer in the n^{th} image information network may be implemented through the following technical solutions: performing query matrix-based mapping on the input of the p^{th} attention layer to obtain an attention query matrix; performing key matrix-based mapping on the action text encoding vector to obtain an attention key matrix; performing value matrix-based mapping on the action text encoding vector to obtain an attention value matrix; multiplying the attention query matrix by a transpose matrix of the attention key matrix to obtain a multiplication result, and obtaining a ratio of the multiplication result to a dimension of the attention key matrix; and performing maximum likelihood processing on the ratio, and multiplying a maximum likelihood result by the attention value matrix to obtain a first attention feature.

In this embodiment of the present disclosure, the action instruction text may be integrated into the image information network in a targeted manner, to restrict image generation, so as to improve a model training effect.

In some embodiments, the downsampling network includes P cascaded attention layers. The performing downsampling on the action text encoding vector and the bypass control result by using the downsampling network to obtain a downsampling result may be implemented through the following technical solutions: performing first attention processing on an input of a p^{th} attention layer and the action text encoding vector by using the p^{th} attention layer in the downsampling network to obtain a first attention feature; performing fusion processing on the first attention feature and the p^{th} attention result output by the p^{th} attention layer in the n^{th} image information network to obtain a p^{th} attention result of the p^{th} attention layer in the downsampling network; transmitting the p^{th} attention result of the p^{th} attention layer in the downsampling network to a (p+1)^{th} attention layer in the downsampling network to obtain a (p+1)^{th} attention result of the (p+1)^{th} attention layer in the downsampling network; and using a p^{th} attention result output by a p^{th} attention layer in the downsampling network as the downsampling result.

In an example, p is an integer variable whose value increases incrementally starting from 1, a value range of p is 1≤p≤P−1, when the value of p is 1, the input of the p^{th} attention layer is the (n−1)^{th} fusion denoising result, and when the value range of p is 2≤p<P, the input of the p^{th} attention layer is a (p−1)^{th} attention result output by a (p−1)^{th} attention layer.

An example in which P is 3 is used for description. First attention processing is performed on an input of a 1^{st} attention layer (an output of a previous cascaded (n−1)^{th} fusion denoising network) and the action text encoding vector by using the 1^{st} attention layer of the downsampling network to obtain a first attention feature. Fusion processing is performed on the first attention feature and a 1^{st} attention result output by a 1^{st} attention layer in the n^{th} image information network to obtain a 1^{st} attention result of the 1^{st} attention layer in the downsampling network; transmitting the 1^{st} attention result of the 1^{st} attention layer in the downsampling network to a 2^{nd} attention layer in the downsampling network to obtain a 2^{nd} attention result of the 2^{nd} attention layer in the downsampling network; and using a 3^{rd} attention result output by a 3^{rd} attention layer in the downsampling network as the downsampling result. In other words, a first attention feature output by each attention layer in the downsampling network of the n^{th} fusion denoising network is fused with an output of a corresponding attention layer in the n^{th} image information network, and a fusion result is transmitted to a next attention layer in the downsampling network for processing.

The image processing method provided in embodiments of the present disclosure continues to be described below. As mentioned above, the electronic device that implements the image processing method provided in embodiments of the present disclosure may be a terminal or a server. An example in which the electronic device is a server is used for description. Therefore, an execution entity of each operation is not repeatedly described below. Refer to FIG. 3E. Descriptions are provided with reference to operation 201 to operation 203 shown in FIG. 3E.

Operation 201: Obtain an image editing request, the image editing request including any one of the following: an image rendering request or an action editing request.

For example, the image editing request is generated based on an editing operation of a user on a terminal device.

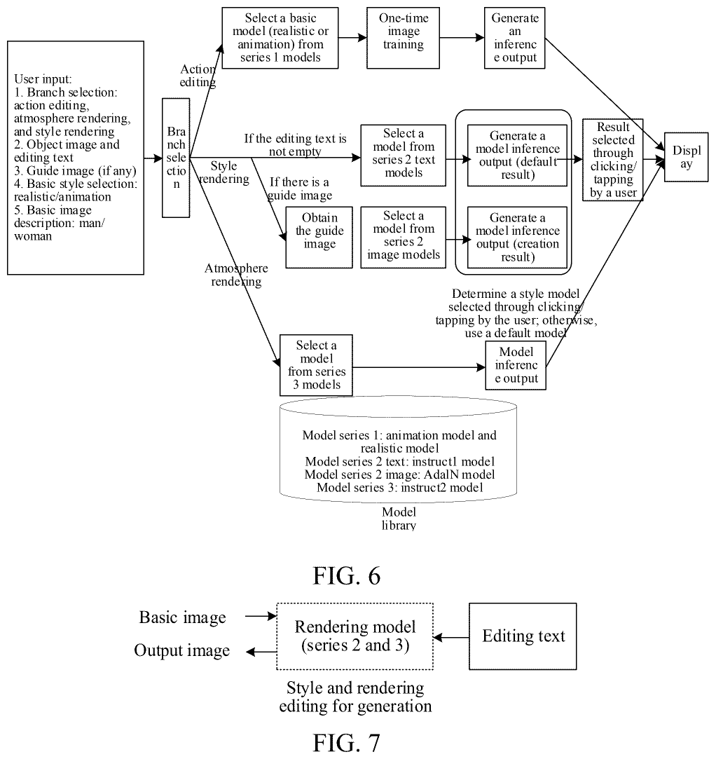

Refer to FIG. 6. An image editing request of a user is received. The image editing request includes any one of the following: an image rendering request or an action editing request. The image rendering request may be a style rendering request or an atmosphere rendering request. The image editing request carries image editing information input by the user. A corresponding image editing branch is determined based on the image editing request. A model library is deployed on the server, and includes a model series 1 (a diffusion model of a realistic style or an anythingV5 model of an animation style), a model series 2, and a model series 3 (an open-source instruct Pix2Pix model). The model series 2 includes a text model (an open-source instruct Pix2Pix model) and an image model (an open-source AdaIN model).

Operation 202: Invoke, when the image editing request is an image rendering request, an image rendering model to perform image rendering on an object image carried in the image editing request to obtain a rendered image.

In an example, the image rendering model can perform at least one of the following processing: a ray projection algorithm, scan line rendering, cube mapping, texture mapping, and the like. The image rendering model may further process various illumination and material effects, for example, reflection, refraction, shadow, transparency, and texture.

Text encoding is performed on the image rendering request by using image rendering model to obtain a text encoding vector. Semantic analysis is performed based on the text encoding vector to obtain a rendering instruction represented by the image rendering request. Image rendering corresponding to the rendering instruction is performed on the object image to obtain the rendered image.

Operation 203: Invoke, when the image editing request is an action editing request, an action editing model to perform the image processing method in embodiments of the present disclosure on an object image carried in the image editing request to obtain a second action image.

In an example, when the image editing request is an action editing request, operation 101 to operation 104 are performed on the object image carried in the image editing request to obtain the second action image, to respond to the action editing request.

For the action editing request, whether a realistic model (a diffusion model) or an animation model (an anythingV5 model) in the series 1 models is used needs to be first determined based on a basic style recorded in the image editing information, and after a model is selected, object image-based fine-tuning (one-time image training) is performed based on an action instruction text to generate a target image (the second action image).

For the style rendering request, a branch that needs to be specifically executed is determined based on whether there is an editing text in the image editing information and whether there is a style guide image. If the editing text is not empty, a model is selected from a text model included in the model series 2 to generate a target image whose style is the same as that of the editing text. If the guide image is not empty, a model is selected from an image model included in the model series 2 to generate a target image whose style is the same as that of the guide image. When both branches are executed, two target images are finally output for the user to select.

For the atmosphere rendering request, a model is selected from the model series 3 to generate a target image whose atmosphere is the same as that of the editing text.

In this embodiment of the present disclosure, a model is provided for each branch of the style rendering request and the atmosphere rendering request. Alternatively, with reference to the action editing request, a realistic model and an animation model are set for each branch, and a corresponding model is selected based on a basic image style. Because original instruct Pix2Pix is a realistic model, actually an animation basic model of the instruct Pix2Pix needs to be trained as an option of an animation model in the model library.

The image processing method provided in embodiments of the present disclosure continues to be described below. As mentioned above, the electronic device that implements the image processing method provided in embodiments of the present disclosure may be a terminal or a server. An example in which the electronic device is a terminal is used for description. Therefore, an execution entity of each operation is not repeatedly described below. An image editing entry is displayed. Input image editing information is displayed in response to an information input operation at the image editing entry, the image editing information including a basic image and editing information, the editing information including at least one of the following: an editing text and a guide image, the editing text being an action instruction text or a rendering text, and the guide image and the rendering text both representing a rendering direction. A target image obtained by editing the basic image based on the editing information is displayed in response to an image processing operation based on the image editing information.

In an example, when the editing text is an action instruction text, the basic image is used as an object image, operation 101 to operation 104 are performed on the object image to obtain a second action image, and the second action image is used as the target image.

In an example, when the editing text is a rendering text, and the rendering text is a style rendering text, a model is selected from a text model included in a model series 2 to generate a target image whose style is the same as that of the editing text. When the editing information includes a guide image, a model is selected from an image model included in the model series 2 to generate a target image whose style is the same as that of the guide image. When the editing text is a rendering text, and the rendering text is an atmosphere rendering text, a model is selected from a model series 3 to generate a target image whose atmosphere is the same as that of the editing text.

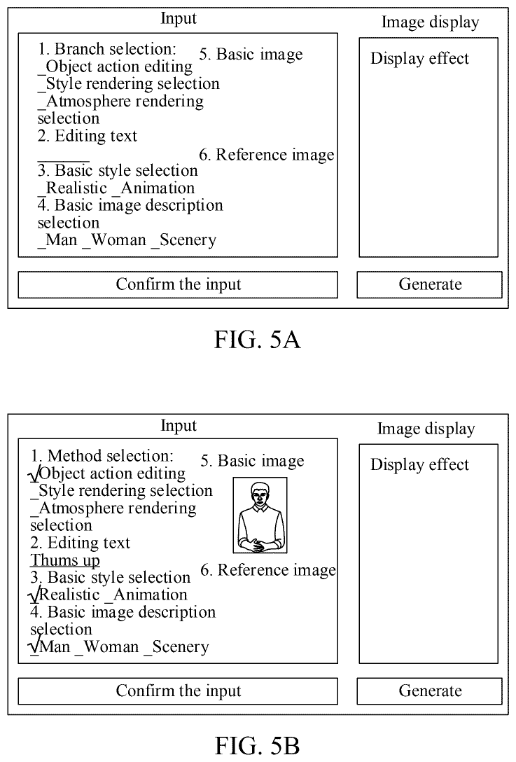

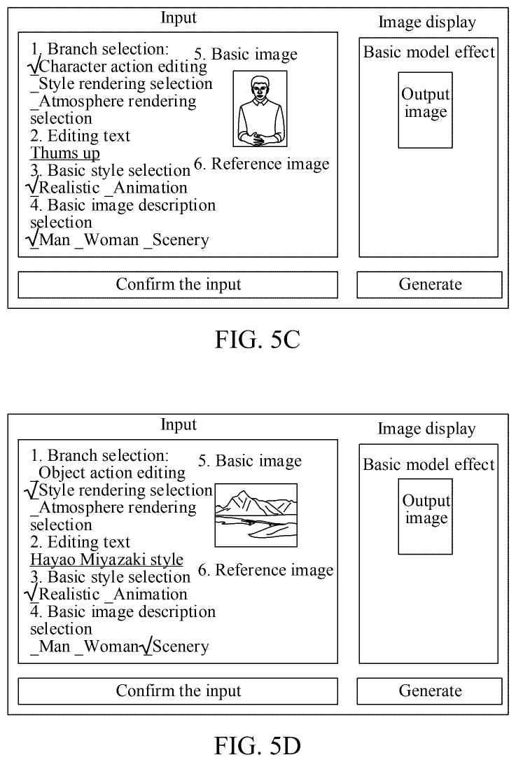

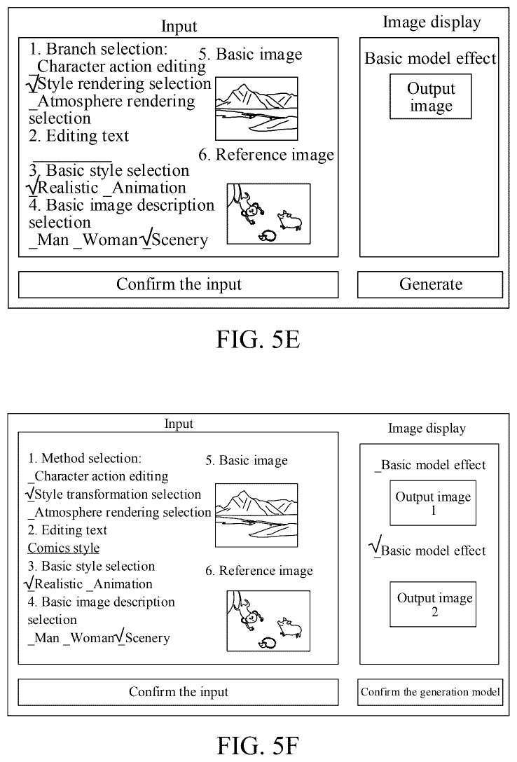

FIG. 5A shows a human-computer interaction interface when no operation is performed. The human-computer interaction interface includes an input control window and an image presentation window.

Refer to FIG. 5B. Input image editing information is displayed in response to an information input operation at an image editing entry. FIG. 5B shows an object image (a basic image) and an editing text. The editing text is “thumbs up”. FIG. 5B further shows a branch (object action editing) corresponding to an image editing request represented by the image editing information, a basic style selection being “realistic” (where correspondingly, a realistic model in a model series 1 is invoked), and a basic image description selection being “man”. In this case, the image presentation window is displayed in grayscale, which indicates that the image presentation window is unavailable. The target image obtained by editing the basic image based on the editing information is displayed in response to the image processing operation based on the image editing information. FIG. 5C shows an output condition after the object action editing is performed. Grayscale display of the image presentation window is canceled, which indicates that the window is enabled. The target image after the object action editing is displayed in the image presentation window.

FIG. 5D shows a result of performing style transformation on the object image based on the style mentioned in the editing text. FIG. 5E shows that an editing result guiding an image style is output when a style guide image is input (instead of the editing text). FIG. 5F shows that two style transformation results are output when the editing text representing the style and the style guide image are input, so that one result may be selected from the two results in the image presentation window for return.

Exemplary application of embodiments of the present disclosure in an actual application scenario is described below.

In some embodiments, a terminal receives an image editing request. The image editing request herein carries an image uploaded by a user and an action instruction text. The terminal transmits the image editing request to a server. The server performs noise addition on an object image to obtain a noisy image encoding vector, performs text encoding on the action instruction text to obtain a first action text encoding vector, denoises the noisy image encoding vector based on the first action text encoding vector to obtain a first action image, updates the first action text encoding vector based on a difference between the first action image and the object image to obtain a second action text encoding vector, perform fusion processing on the first action text encoding vector and the second action text encoding vector to obtain a fused action text encoding vector, denoises the noisy image encoding vector based on the fused action text encoding vector to obtain a second action image that is obtained by applying an action corresponding to the action instruction text to the object image, and returns the second action image to the terminal.

Image editing includes the following a plurality of cases: 1. A scene needs to show changes in morning, afternoon, and night, to be used as transition pictures showing a time change. 2. An image needs to be converted into a specified style. 3. A character hand action in the figure needs to be changed into a thumbs-up action or the like. The foregoing image editing includes a plurality of input cases and a plurality of image position editing (where for example, an entire image needs to be changed when an image style or atmosphere is changed, and a partial image needs to be changed when an action is changed). In addition, different model processing is needed for different image editing capabilities, for example, when image style editing is performed, original image information needs to be maintained as much as possible in different image styles; when time changes, a model that maintains main information of an entire picture unchanged needs to be generated; and when an action is changed, fine-tuning needs to be performed on the model to regenerate a model. An image editing system in the related art cannot support object action editing. In addition, a plurality of editing capabilities are deployed on different positions in the system to cause different functions, and when editing needs to be performed, it is not easy for a user to find a corresponding function key.

An embodiment of the present disclosure designs a system supporting a creative image editing capability of a user, and a plurality of types of creative editing may be implemented through unified input. The system provided in this embodiment of the present disclosure selects an editing model based on a user input, performs image editing based on the selected editing model, and presents a final result after the image editing.

In this embodiment of the present disclosure, object action editing (including training and inference to implement effective editing) and scene time change editing are introduced, to greatly improve an editable range of an image. In addition, generation of a plurality of editing capabilities is supported by using a unified entry, including time change editing, object action editing, style transformation, and the like during full image rendering. Model training and image generation with a current optimal generation effect are integrated by a service in this embodiment of the present disclosure through scheduling and combination of modules with separate functions, to finally implement creative image generation for a user.

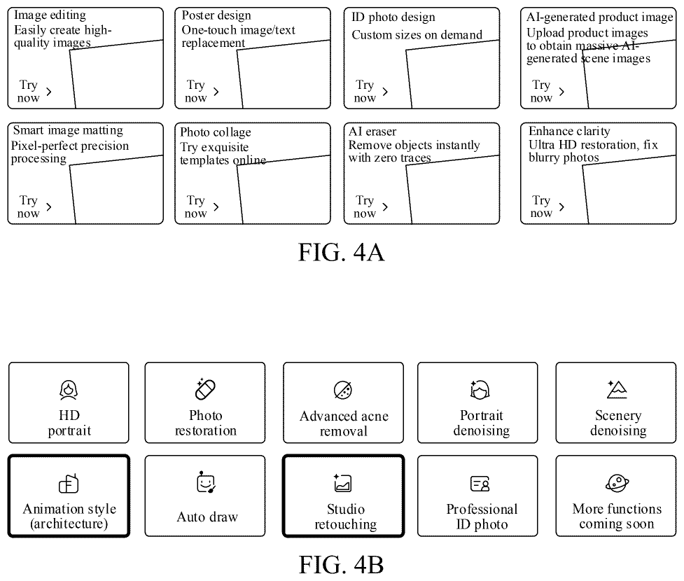

Refer to FIG. 4A and FIG. 4B. In a solution in the related art, only simple physical editing such as style transformation and adding a filter effect on an image is provided, and object action editing, semantic image editing (for example, raining, snowy, and turning into the night), style transformation editing based on reference image guiding, and the like cannot be performed. In addition, software function options are distributed at a plurality of positions on a page, for example, animation style, image editing, and studio retouching. A user needs to attempt to obtain a needed editing function from a plurality of entries, and this wastes time of enters an application by the user, has low use efficiency, and causes annoyance to the user.

An object action editing solution in the related art may not ensure image consistency. In addition, it is not easy for an image editing APP in the related art to simultaneously provide style rendering and semantic image rendering (for example, time atmosphere rendering). Moreover, function options of the image editing APP in the related art are distributed at a plurality of position on a page, which is not convenient for a user to use.

In this embodiment of the present disclosure, an object action editing capability is introduced to implement semantic action editing, so that text representation of an input image can be fine-tuned, and action editing is performed based on the fine-tuned text representation, without needing manual participation of a user during internal invoking of a service.

In this embodiment of the present disclosure, various forms of editing such as atmosphere rendering on a semantic level, style rendering with or without a guide image may further be implemented, to enrich the overall editing functions.

In this embodiment of the present disclosure, a model is invoked by using a unified image editing input interface. After the user specifies an input, the system determines, based on information that is input in a unified manner, an editing capability to be invoked. In addition, a plurality of functions are supported, such as inputs (a text and an image) needed by different editing, directly invoking a model for editing, and performing fine-tuning on a model for editing, to reduce time for searching various function entries by user and improve editing efficiency.

FIG. 7 shows a model inference process of image atmosphere rendering and style editing according to an embodiment of the present disclosure. An editing text (representing a style) and a basic image are input to a model in a model series 2 to obtain an output image on which style rendering is performed. An editing text (representing an atmosphere) and a basic image are input to a model in a model series 3 to obtain an output image on which atmosphere rendering is performed.

Image atmosphere rendering is described below. An open source-based instruct Pix2Pix model is used in an atmosphere rendering model in this embodiment of the present disclosure. An image and an editing text are input, and then a target image is generated by using the model. The editing text needs to be first translated into English, for example, python edit_cli.py—input input_image.jpg—output output.jpg—edit “make it nighttime”. In this embodiment of the present disclosure, the atmosphere rendering model may be replaced. In addition to using the open-source model, a newly trained model may alternatively be used. For example, a batch of new rendering data is collected according to the open-source model method (where this model needs a large quantity of training samples, and therefore, it needs to be ensured that 100 or more pieces of training data are collected for each editing instruction), and the foregoing instruct Pix2Pix model is fine-tuned and trained to obtain a newly trained atmosphere rendering model.

Text-based style editing is described below. In this embodiment of the present disclosure, an open-source instruct Pix2Pix model is used to input an image and a style editing instruction (a Hayao Miyazaki style), then a target image is generated by using the model, and an editing text needs to be first translated into English. To be specific, the following editing instruction is input: “python edit_cli.py-input—input_image.jpg—output output.jpg—edit “Hayao Miyazaki style””.

Image-based style editing is described below. In this embodiment of the present disclosure, an open source AdaIN model is used. The model supports in inputting an object image and a style guide image, to generate an image of target content in a guide style, and a generation instruction is “python test.py—content input_image.jpg—style reference_image.jpg”.

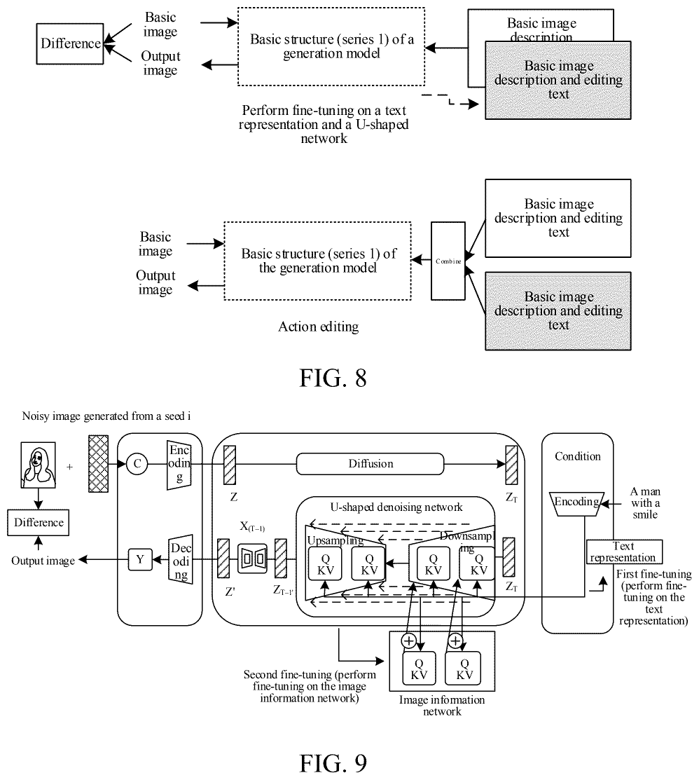

FIG. 8 shows an object action editing process. A basic image description and an editing text form an action instruction text. The action instruction text and a basic image are input to an action editing model (a basic structure of a generation model, that is, a U-shaped network) from a model series 1, to obtain an output image. Fine-tuning is performed on a text representation (embedding) of the action instruction text and the action editing model (the U-shaped network) based on a difference between the output image and the basic image. An original representation of the action instruction text and a fine-tuned representation are combined. A combination result and the basic image are input to the fine-tuned action editing model to obtain an output image.

Object action editing is described below. In this embodiment of the present disclosure, the object action editing is generated based on a diffusion model. For object action editing, first, it needs to be ensured that a generated image needs to be sufficiently similar to an original image. The time rendering and style rendering models are more effective in ensuring image consistency (where this is because training samples of the models are consistent samples, in other words, image content is the same before and after editing). However, it is not easy for an object action editing technology to ensure image consistency before and after editing.

Therefore, in this embodiment of the present disclosure, based on the diffusion model (used as the action editing model) having a good generation effect, a mechanism for performing fine-tuning in applications is provided. An original object image and an action instruction text are fine-tuned into the action editing model, to implement cognition of the model for the object image. Then, a representation of the fine-tuned action instruction text and a representation of the original action instruction text are combined to generate a new representation, and the action editing model is driven by using the new representation to generate a target image.

An implementation principle of the diffusion model provided in this embodiment of the present disclosure is: Noise addition on is performed on an original image, and encoding is performed on the image for mapping into a latent feature space through variable automatic encoding. A latent space representation at a moment T is obtained through a diffusion process. An original image feature to which no noise is added is restored through a denoising process operation for T times. Variable automatic decoding is performed on a restored encoding feature to obtain the target image. For the action instruction text, after text embedding encoding is implemented through a CLIP text branch, controlling is performed according to an attention mechanism of a U-shaped network. Diffusion sampling is for obtaining a latent space representation of a noisy image encoding vector, and subsequently, learning is performed in a denoising process of the noisy image encoding vector to generate a fitted noise representation, so that the noise representation is removed from the original image to obtain an image representation that is truly needed, and an image that is truly needed is obtained by using a decoder.

Because object action editing cannot be performed in an image-to-image mechanism, in this embodiment of the present disclosure, object action editing is ensured in the following method: (1) performing fine-tuning on image information and the action instruction text as training samples to the text representation, to cause the text representation to include the image information; (2) using the image information and a control text as training samples for fine-tuning of a bypass generation control structure, that is, an image information network of a model, to ensure by using the bypass structure that an image generated by using the model is more similar to an original image; and (3) concatenating the text representation that is not fine-tuned and the text representation that is fine-tuned to obtain a text representation with strong control, and generating an image by using the fine-tuned model.

Refer to FIG. 9. In a process of performing fine-tuning of object action editing, fine-tuning of a text representation and fine-tuning of an image information network are sequentially performed. For example, if an editing text input by a user is “smile”, and a basic image description is “a man”, an action instruction text is “a man with a smile”. Herein, a random seed i is selected to generate a noisy image, the noisy image and a basic image are superimposed to generate a superimposed image C, and encoding and latent space representation (a diffusion process) are performed on the superimposed image C to obtain a noisy image encoding vector Zr. First, the noisy image encoding vector and an original text representation of the action instruction text are input into T cascaded U-shaped denoising networks shown in FIG. 9 (where each sampling layer in the U-shaped denoising networks is an attention layer, and the attention layer is denoted as QKV in FIG. 9), and an intermediate result Z_{T-1}′ can be obtained by using a 1^{st} U-shaped denoising network. Then, processing continues to be performed by using a 2^{nd} U-shaped denoising network X_{T-1}. A final output result Z′ is decoded to obtain an output image Y. The original text representation of the action instruction text is fine-tuned based on a difference between the output image Y and the basic image. In this case, the original representation of the action instruction text is directly fine-tuned by using an original diffusion model without using the image information network, to obtain a fine-tuned representation. Subsequently, the image information network is fine-tuned. For the diffusion model, a model structure is not directly fine-tuned, but the bypassed image information network is fine-tuned. Supervised image information is fine-tuned to the bypassed image information network, so that the image information is embedded into an action editing model.

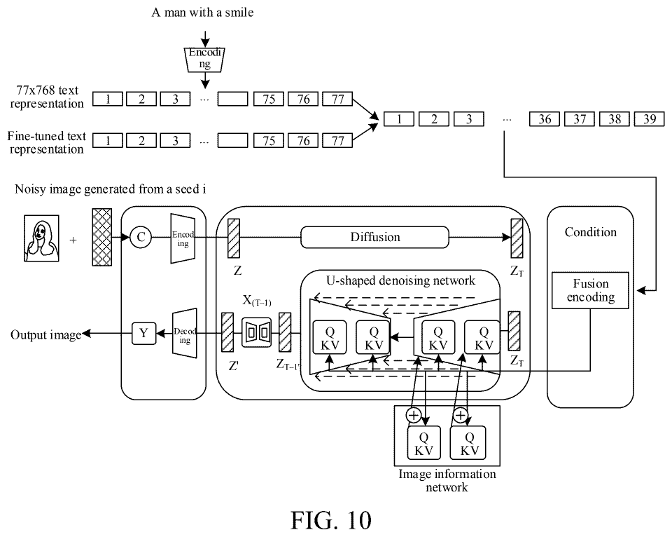

Refer to FIG. 10. In an inference process in object action editing, a random seed i is selected to generate a noisy image, the noisy image and a basic image are superimposed to generate a superimposed image C, and encoding and latent space representation (a diffusion process) are performed on the superimposed image C to obtain a noisy image encoding vector Z_{T}. First, an original text representation is fine-tuned in the foregoing method, a fine-tuned text representation and the text representation that is not fine-tuned are concatenated to generate a final text representation (fusion encoding), and the final text representation and the noisy image encoding vector are input into an action editing model in which an image information network is fine-tuned, to generate an output image. Specifically, the action editing model shown in FIG. 10 includes T cascaded U-shaped denoising networks (where each sampling layer in the U-shaped denoising network is an attention layer) and the image information network, and the image information network is also obtained by cascading a plurality of attention layers. In FIG. 10, the attention layer is denoted as QKV. An intermediate result Z_{T-1}′ may be obtained by using a 1^{st} U-shaped denoising network. Then, denoising continues to be performed by using a 2^{nd} U-shaped denoising network X_{T-1}. A final output result Z′ is decoded to obtain an output image Y.

Herein, the text representation that is not fine-tuned needs to be placed at the front. The text representation that is not fine-tuned retains more editing capabilities, the fine-tuned text representation represents the basic image, and basic image information cannot provide editing control information. Therefore, the text representation that is not fine-tuned needs to be placed at the front to ensure a higher editing capability. In addition, because the action instruction text is short, the first 38 vectors are sufficient to cover all meaningful text representations. Therefore, finally, the text representation adopts a structure of first 38 vectors and then 39 vectors for concatenation, which is sufficient to satisfy requirements for action editing requirement and basic image representation. During combination, a text representation (embedding) concatenation method may be used, or a method of embedding weighted summation may be used to obtain final embedding.

A fine-tuning process is described below. A fine-tuned image-text pair is (basic image, action instruction text), to be specific, (basic image, a man with a big smile). A total of N (for example, 20) rounds of iteration are performed on one input image. In each iteration process, a process in which one input image is trained in the model for once is referred to as a round of iteration. Image-text pair samples are used for training. For an image-text pair sample, after noise addition is performed on an original image, the image is input as a noisy image to a variation autoencoder. A text is used for generating a constraint, and the original image is used for loss calculation. A training solution is described below.

First, parameter initialization is performed. Parameters of a trained open-source diffusion model are used for the variation autoencoder, a text encoder, and the U-shaped network. In addition, in this training, only a parameter of the U-shaped network needs to be updated, and other parameters are not updated. A learning rate of 0.0004 is used for initialization, and in the subsequent learning, after every 10 rounds of learning, the learning rate becomes 0.1 times of the original learning rate, for a total of 20 rounds of training.

Next, a random seed i is selected to generate a noisy image, the noisy image and an original image are superimposed to generate an image x, and the image x passes a latent space representation to generate Z_{T}. Then, text information passes a text-image contrastive model to obtain a text representation. The text representation is input into the action editing model (where the text representation is used as KV information). Forward calculation is performed on the U-shaped network for T times on Zr under a KV constraint. Z_{T-1} is obtained after a 1^{st} forward calculation. Finally, after T times, the U-shaped network outputs a prediction Z₀, and a prediction image is obtained by using a decoding network.

Next, a batch loss is calculated, to be specific, statistics on a total loss of this batch of samples are collected. Specifically, mean square error calculation is performed on the output prediction image and the image in the image-text pair to obtain a mean square error (MSE) loss. In an example, refer to Formula (5):

$$M S E = {\sum }_{i = 1}^{n} {( {y}_{i} - {y}_{i}^{p} )}^{2} . \qquad ( 5 )$$

yᵢ is a second pixel value at a position i in the original image.

$${y}_{i}^{p}$$

is a first pixel value at a position i in a generated image. MSE is a difference between the original image and the generated image.

Then, a stochastic gradient descent method is used to inversely return the loss to the model to obtain a gradient of the model parameter (U-Net) and update the parameter. At last, training on all the plurality of batches is completed, and iteration is ended.

In some embodiments, a type of editing is selected is determined based on information input in a unified manner, different branches are used for processing based on the selected editing (style rendering, atmosphere rendering, and object action editing), and a generated image is returned to a user. For style rendering with both an editing text description and a reference image, generation effects of two branches are provided for a user to select.

Embodiments of the present disclosure introduce an object action editing capability to implement semantic character image editing and provide an effective object action editing method. In embodiments of the present disclosure, a plurality of forms of editing such as image time atmosphere rendering on a semantic level and style transformation editing with or without a guide image are introduced, to enrich overall editing functions. In embodiments of the present disclosure, after a user specifies an input through a unified semantic image editing input interface, a system generates an image based on a unified input information service, and returns the image for display, to reduce time for exploring an application by the user and improve editing efficiency.

In embodiments of the present disclosure, related data such as user information is included. When embodiments of the present disclosure are applied to specific product or technology, user permission or consent needs to be obtained, and collection, use, and processing of the related data need to comply with relevant laws, regulations, and standards of relevant countries and regions.

An exemplary structure in which an image processing apparatus 255-1 provided in an embodiment of the present disclosure is implemented as a software module continues to be described below. In some embodiments, as shown in FIG. 2, software modules in the image processing apparatus 255-1 stored in a memory 250 may include: an encoding module 2551, configured to: perform noise addition on an object image to obtain a noisy image encoding vector, and perform text encoding on an action instruction text to obtain a first action text encoding vector; a fine-tuning module 2552, configured to: denoise the noisy image encoding vector based on the first action text encoding vector to obtain a first action image, and update the first action text encoding vector based on a difference between the first action image and the object image to obtain a second action text encoding vector; a fusion module 2553, configured to perform fusion processing on the first action text encoding vector and the second action text encoding vector to obtain a fused action text encoding vector; and a generation module 2554, configured to denoise the noisy image encoding vector based on the fused action text encoding vector to obtain a second action image, the second action image being a result of applying an action corresponding to the action instruction text to an object included in the object image.

In some embodiments, the text encoding is implemented by invoking a text model in a text-image contrastive model. The encoding module 2551 is further configured to: obtain a plurality of first text samples and first image samples matching the first text samples, respectively; perform image encoding on each first image sample by using a visual model of the text-image contrastive model to obtain an image encoding vector of each first image sample; perform text encoding on each first text sample by using the text model of the text-image contrastive model to obtain a text encoding vector of each first text sample; determine a text-image contrastive loss based on the text encoding vector of each first text sample, the image encoding vector of each first image sample, and a matching relationship between each first text sample and each first image sample; and update a parameter of the text-image contrastive model based on the text-image contrastive loss.

In some embodiments, the encoding module 2551 is further configured to: superimpose the object image and a noisy image to obtain a superimposed image; and perform image latent space encoding on the superimposed image to obtain the noisy image encoding vector.

In some embodiments, the denoising based on the first action text encoding vector is implemented by using an image generation model. The image generation model includes N cascaded denoising networks and a decoding network, and a value range of N is 2≤N. The fine-tuning module 2552 is further configured to: denoise an input of an n^{th} denoising network by using the n^{th} denoising network among the N cascaded denoising networks, and transmit an n^{th} denoising result output by the n^{th} denoising network to an (n+1)^{th} denoising network for subsequent denoising to obtain an (n+1)^{th} denoising result corresponding to the (n+1)^{th} denoising network; and decode, by using the decoding network, a denoising result output by an N^{th} denoising network to obtain the first action image, n being an integer variable whose value increases incrementally starting from 1 (e.g., incrementing by 1 each time), a value range of n being 1≤n<N, when the value of n is 1, the input of the n^{th} denoising network being the noisy image encoding vector and the first action text encoding vector, and when the value range of n is 2≤n<N, the input of the n^{th} denoising network being an (n−1)^{th} denoising result output by an (n−1)^{th} denoising network and the first action text encoding vector.

In some embodiments, the n^{th} denoising network includes M cascaded attention layers. The fine-tuning module 2552 is further configured to: perform first attention processing on an input of an m^{th} attention layer and the first action text encoding vector by using the m^{th} attention layer in the n^{th} denoising network to obtain a first attention feature as an m^{th} attention result of the m^{th} attention layer in the n^{th} denoising network; transmit the m^{th} attention result of the m^{th} attention layer in the n^{th} denoising network to an (m+1)^{th} attention layer for subsequent attention processing to obtain an (m+1)^{th} attention result of the (m+1)^{th} attention layer in the n^{th} denoising network; and use an M^{th} attention result output by an M^{th} attention layer in the n^{th} denoising network as the n^{th} denoising result, m being an integer variable whose value increases incrementally starting from 1 (e.g., incrementing by 1 in each round), a value range of m being 1≤m≤M−1, when the value of m is 1, the input of the m^{th} attention layer being the (n−1)^{th} denoising result, and when the value range of m is 2≤m<M, the input of the m^{th} attention layer being an (m−1)^{th} attention result output by an (m−1)^{th} attention layer.

In some embodiments, the fine-tuning module 2552 is further configured to: perform query matrix-based mapping processing on the input of the m^{th} attention layer to obtain an attention query matrix; perform key matrix-based mapping on the first action text encoding vector to obtain an attention key matrix; perform value matrix-based mapping on the first action text encoding vector to obtain an attention value matrix; multiply the attention query matrix by a transpose matrix of the attention key matrix to obtain a multiplication result, and obtain a ratio of the multiplication result to a dimension of the attention key matrix; and perform maximum likelihood processing on the ratio, and multiply a maximum likelihood result by the attention value matrix to obtain a first attention feature.

In some embodiments, the fine-tuning module 2552 is further configured to: obtain a first pixel value at each position in the first action image and a second pixel value at each position in the object image; obtain, for each position, a difference between the first pixel value and the second pixel value; and perform fusion processing on differences at a plurality of positions to obtain the difference between the first action image and the object image, and update the first action text encoding vector based on a first loss to obtain the second action text encoding vector.

In some embodiments, the denoising based on the first action text encoding vector is implemented by using the image generation model. The fine-tuning module 2552 is further configured to: update, when updating the first action text encoding vector based on the difference between the first action image and the object image, the image generation model based on the difference between the first action image and the object image to obtain an updated image generation model.

In some embodiments, the fusion module 2553 is further configured to: perform truncation on the first action text encoding vector based on a first quantity to obtain a first truncated encoding vector, the first truncated encoding vector including a first quantity of vectors from the beginning of the first action text encoding vector; perform truncation on the second action text encoding vector based on a second quantity to obtain a second truncated encoding vector, the second truncated encoding vector including a second quantity of vectors from the beginning of the second action text encoding vector; and concatenate the second truncated encoding vector to a tail of the first truncated encoding vector to obtain the fused action text encoding vector.

In some embodiments, the denoising based on the first action text encoding vector is implemented by using the image generation model, the denoising based on the fused action text encoding vector is implemented by using an image editing model, and the image editing model includes the image generation model and a plurality of image information networks. Before the denoising the noisy image encoding vector based on the fused action text encoding vector to obtain a second action image, the generation module 2554 is further configured to: perform forward propagation in the image editing model on the noisy image encoding vector and the first action text encoding vector to obtain a third action image; and update the plurality of image information networks in the image editing model based on a difference between the third action image and the object image to obtain an updated image editing model.

In some embodiments, the image generation model includes N cascaded denoising networks and a decoding network, a value range of N is 2≤N, the image editing model is obtained by configuring, based on the image generation model, an image information network for each denoising network, each denoising network and the corresponding image information network form a fusion denoising network, and a cascade relationship between a plurality of fusion denoising networks is the same as a cascade relationship between the plurality of denoising networks. The generation module 2554 is further configured to: perform fusion denoising on an input of an n^{th} fusion denoising network by using the n^{th} fusion denoising network among N cascaded fusion denoising networks, and transmit an n^{th} fusion denoising result output by the n^{th} fusion denoising network to an (n+1)^{th} fusion denoising network for subsequent fusion denoising to obtain an (n+1)^{th} fusion denoising result corresponding to the (n+1)^{th} fusion denoising network; and decode a fusion denoising result output by an N^{th} fusion denoising network to obtain the third action image, n being an integer variable whose value increases incrementally starting from 1, a value range of n being 1≤n<N, when the value of n is 1, the input of the n^{th} fusion denoising network being the noisy image encoding vector and the first action text encoding vector, and when the value range of n is 2≤n<N, the input of the n^{th} fusion denoising network being an (n−1)^{th} fusion denoising result output by an (n−1)^{th} fusion denoising network and the first action text encoding vector.

In some embodiments, the n^{th} fusion denoising network includes a plurality of downsampling networks, a plurality of upsampling networks, and an n^{th} image information network corresponding to the n^{th} denoising network. The generation module 2554 is configured to: perform bypass control on the noisy image encoding vector and the first action text encoding vector by using the n^{th} image information network to obtain a bypass control result; perform downsampling on the first action text encoding vector and the bypass control result by using the downsampling network to obtain a downsampling result; and perform upsampling on the downsampling result by using the upsampling network to obtain the n^{th} fusion denoising result.

In some embodiments, the n^{th} image information network includes P cascaded attention layers. The generation module 2554 is further configured to: transmit a p^{th} attention result of a p^{th} attention layer in the n^{th} image information network to a (p+1)^{th} attention layer for subsequent second attention processing to obtain a (p+1)^{th} attention result of the (p+1)^{th} attention layer in the n^{th} image information network; and use a second attention result output by each attention layer as the bypass control result, p being an integer variable whose value increases incrementally starting from 1, a value range of p being 1≤p≤P−1, when the value of p is 1, an input of the p^{th} attention layer being the (n−1)^{th} fusion denoising result, and when the value range of p is 2≤p<P, the input of the p^{th} attention layer being a (p−1)^{th} attention result output by a (p−1)^{th} attention layer in the n^{th} image information network.

In some embodiments, the downsampling network includes P cascaded attention layers. The generation module 2554 is configured to: perform first attention processing on an input of a p^{th} attention layer and the first action text encoding vector by using the p^{th} attention layer in the downsampling network to obtain a first attention feature; perform fusion processing on the first attention feature and the p^{th} attention result output by the p^{th} attention layer in the n^{th} image information network to obtain a p^{th} attention result of the p^{th} attention layer in the downsampling network; transmit the p^{th} attention result of the p^{th} attention layer in the downsampling network to a (p+1)^{th} attention layer in the downsampling network to obtain a (p+1)^{th} attention result of the (p+1)^{th} attention layer in the downsampling network; and using a p^{th} attention result output by a p^{th} attention layer in the downsampling network as the downsampling result, p being an integer variable whose value increases incrementally starting from 1, a value range of p being 1≤p≤P−1, when the value of p is 1, the input of the p^{th} attention layer being the (n−1)^{th} fusion denoising result, and when the value range of p is 2≤p<P, the input of the p^{th} attention layer being a (p−1)^{th} attention result output by a (p−1)^{th} attention layer.

An exemplary structure in which an image processing apparatus 255-2 provided in an embodiment of the present disclosure is implemented as a software module continues to be described below. In some embodiments, as shown in FIG. 2, software modules in the image processing apparatus 255-2 stored in a memory 250 may include: an obtaining module 2556, configured to obtain an image editing request, the image editing request including any one of the following: an image rendering request or an action editing request; a rendering module 2557, configured to invoke, when the image editing request is an image rendering request, an image rendering model to perform image rendering on an object image carried in the image editing request to obtain a rendered image; and an action module 2558, configured to invoke, when the image editing request is an action editing request, an image editing model to perform the image processing method in embodiments of the present disclosure on an object image carried in the image editing request to obtain a second action image.

An exemplary structure in which an image processing apparatus provided in an embodiment of the present disclosure is implemented as a software module continues to be described below. In some embodiments, software modules in the image processing apparatus stored in a memory may include: a display module, configured to display an image editing entry; an input module, configured to display, in response to an information input operation at the image editing entry, input image editing information, the image editing information including a basic image and editing information, the editing information including at least one of the following: an editing text and a guide image, the editing text being an action instruction text or a rendering text, and the guide image and the rendering text both representing a rendering direction; and an editing module, configured to display, in response to an image processing operation based on the image editing information, a target image obtained by editing the basic image based on the editing information.

An embodiment of the present disclosure provides a computer program product. The computer program product includes computer-executable instructions. The computer-executable instructions are stored in a computer-readable storage medium. A processor of an electronic device reads the computer-executable instructions from the computer-readable storage medium. The processor executes the computer-executable instructions, to enable the electronic device to perform the method described in embodiments of the present disclosure.

An embodiment of the present disclosure provides a computer-readable storage medium having computer-executable instructions stored thereon. When executed by a processor, the computer-executable instructions cause the processor to perform the method provided in embodiments of the present disclosure.

In some embodiments, the computer-readable storage medium may be a memory, for example, a ferroelectric random access memory (FRAM), a ROM, a programmable read-only memory (PROM), an electrically programmable read-only memory (EPROM), an electrically erasable programmable read-only memory (EEPROM), a flash memory, a magnetic surface memory, an optical disc, or a compact disc read-only memory (CD-ROM), or may be a variety of devices including one of the foregoing memories or any combination.

In some embodiments, the computer-executable instructions may be in the form of programs, software, software modules, or scripts, written in any form of programming language (including compiled or interpreted languages, or declarative or procedural languages), and may be deployed in any form, including being deployed as a standalone program or as a module, component, subroutine, or another unit suitable for use in a computing environment.

In an example, the computer-executable instruction may, but not necessarily, correspond to a file in a file system, and may be stored as a part of a file that stores other programs or data, for example, stored in one or more scripts stored in a hypertext markup language (HTML) document, stored in a single file dedicated to the program under discussion, or stored in a plurality of collaborative files (for example, a file that store one or more modules or subroutines).

In an example, the executable instructions may be deployed to be executed on a single electronic device, or on a plurality of electronic devices located at a single location, or on a plurality of electronic devices distributed in a plurality of locations and interconnected via a communication network.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

In conclusion, in embodiments of the present disclosure, noise addition is performed on an object image to obtain a noisy image encoding vector, and text encoding is performed on an action instruction text to obtain a first action text encoding vector. The noisy image encoding vector is denoised based on the first action text encoding vector to obtain a first action image, and the first action text encoding vector is updated based on a difference between the first action image and the object image to obtain a second action text encoding vector. Herein, this is equivalent to performing fine-tuning on a representation of the action instruction text, to ensure cognition about an original object image in an image processing process and control consistency in an image editing process. Fusion processing is performed on the first action text encoding vector and the second action text encoding vector to obtain a fused action text encoding vector. The noisy image encoding vector is denoised based on the fused action text encoding vector to obtain a result of applying an action corresponding to the action instruction text to an object included in the object image. Because the result is generated based on control of the fused action text encoding vector, action editing can be implemented while ensuring image consistency.

The foregoing descriptions are merely embodiments of the present disclosure and are not intended to limit the scope of protection of the present disclosure. Any modification, equivalent replacement, and improvement made within the spirit and scope of the present disclosure fall within the protection scope of the present disclosure.

What is claimed is:

1. An artificial intelligence-based image processing method, performed by an electronic device, the method comprising:
performing noise addition on an object image to obtain a noisy image encoding vector;
performing text encoding on an action instruction text to obtain a first action text encoding vector;
denoising the noisy image encoding vector based on the first action text encoding vector to obtain a first action image, the denoising based on the first action text encoding vector being performed iteratively, a denoising result of a current round of the denoising being an input of a next round of the denoising, and the first action image being obtained by decoding a denoising result of a final round of the denoising;
updating the first action text encoding vector based on a difference between the first action image and the object image to obtain a second action text encoding vector;
performing fusion processing on the first action text encoding vector and the second action text encoding vector to obtain a fused action text encoding vector; and
denoising the noisy image encoding vector based on the fused action text encoding vector to obtain a second action image, the second action image being a result of applying an action corresponding to the action instruction text to an object comprised in the object image.

2. The method according to claim 1, wherein the text encoding is implemented by invoking a text model in a text-image contrastive model, and the method further comprises:
obtaining a plurality of first text samples and first image samples respectively matching the first text samples;
performing image encoding on each first image sample by using a visual model of the text-image contrastive model to obtain an image encoding vector of each first image sample;
performing text encoding on each first text sample by using the text model of the text-image contrastive model to obtain a text encoding vector of each first text sample;
determining a text-image contrastive loss based on the text encoding vector of each first text sample, the image encoding vector of each first image sample, and a matching relationship between each first text sample and each first image sample; and
updating a parameter of the text-image contrastive model based on the text-image contrastive loss.

3. The method according to claim 1, wherein the performing noise addition on an object image to obtain a noisy image encoding vector comprises:
superimposing the object image and a noisy image to obtain a superimposed image; and
performing image latent space encoding on the superimposed image to obtain the noisy image encoding vector.

4. The method according to claim 1, wherein the denoising the noisy image encoding vector based on the first action text encoding vector is implemented by using an image generation model, the image generation model comprises N cascaded denoising networks and a decoding network, and a value of N is greater than or equal to 2; and
the denoising the noisy image encoding vector based on the first action text encoding vector to obtain a first action image comprises:
denoising an input of an n^{th} denoising network by using the n^{th} denoising network among the N cascaded denoising networks, and transmitting an n^{th} denoising result output by the n^{th} denoising network to an (n+1)^{th} denoising network for subsequent denoising to obtain an (n+1)^{th} denoising result corresponding to the (n+1)^{th} denoising network, n being an integer between 1 and N−1; and
decoding, by using the decoding network, a denoising result output by an N^{th} denoising network to obtain the first action image,
n having a value increases incrementally by 1, in response to the value of n being 1, the input of the n^{th} denoising network being the noisy image encoding vector and the first action text encoding vector, and in response to the value range of n being 2≤n<N, the input of the n^{th} denoising network being an (n−1)^{th} denoising result output by an (n−1)^{th} denoising network and the first action text encoding vector.

5. The method according to claim 4, wherein the n^{th} denoising network comprises M cascaded attention layers, and a value of M is greater than or equal to 2; and
the denoising an input of an n^{th} denoising network by using the n^{th} denoising network among the N cascaded denoising networks comprises:
performing first attention processing on an input of an m^{th} attention layer and the first action text encoding vector by using the m^{th} attention layer in the n^{th} denoising network to obtain a first attention feature as an m^{th} attention result of the m^{th} attention layer in the n^{th} denoising network;
transmitting the m^{th} attention result of the m^{th} attention layer in the n^{th} denoising network to an (m+1)^{th} attention layer for subsequent attention processing to obtain an (m+1)^{th} attention result of the (m+1)^{th} attention layer in the n^{th} denoising network; and
using an M^{th} attention result output by an M^{th} attention layer in the n^{th} denoising network as the n^{th} denoising result,
m being an integer variable whose value increases incrementally starting from 1, a value range of m being 1≤m≤M−1, in response to the value of m being 1, the input of the m^{th} attention layer being the (n−1)^{th} denoising result, and in response to the value range of m being 2≤m<M, the input of the m^{th} attention layer being an (m−1)^{th} attention result output by an (m−1)^{th} attention layer.

6. The method according to claim 5, wherein the performing first attention processing on an input of an m^{th} attention layer and the first action text encoding vector by using the m^{th} attention layer in the n^{th} denoising network comprises:
performing query matrix-based mapping on the input of the m^{th} attention layer to obtain an attention query matrix;
performing key matrix-based mapping on the first action text encoding vector to obtain an attention key matrix;
performing value matrix-based mapping on the first action text encoding vector to obtain an attention value matrix;
multiplying the attention query matrix by a transpose matrix of the attention key matrix to obtain a multiplication result, and obtaining a ratio of the multiplication result to a dimension of the attention key matrix; and
performing maximum likelihood processing on the ratio, and multiplying a maximum likelihood result by the attention value matrix to obtain the first attention feature.

7. The method according to claim 1, further comprising:
obtaining, for each of a plurality of positions, a first pixel value at the position in the first action image and a second pixel value at the corresponding position in the object image;
obtaining, for each of the plurality of positions, a difference between the first pixel value and the second pixel value; and
performing fusion processing on differences at the plurality of positions to obtain the difference between the first action image and the object image.

8. The method according to claim 1, wherein the denoising based on the first action text encoding vector is implemented by using the image generation model, and the method further comprises:
updating, while updating the first action text encoding vector based on the difference between the first action image and the object image, the image generation model based on the difference between the first action image and the object image to obtain an updated image generation model.

9. The method according to claim 1, wherein the performing fusion processing on the first action text encoding vector and the second action text encoding vector to obtain a fused action text encoding vector comprises:
truncating the first action text encoding vector based on a first quantity to obtain a first truncated encoding vector, the first truncated encoding vector comprising the first quantity of vectors from a beginning of the first action text encoding vector;
truncating the second action text encoding vector based on a second quantity to obtain a second truncated encoding vector, the second truncated encoding vector comprising the second quantity of vectors from a beginning of the second action text encoding vector; and
concatenating the second truncated encoding vector to a tail of the first truncated encoding vector to obtain the fused action text encoding vector.

10. The method according to claim 1, wherein the denoising based on the first action text encoding vector is implemented by using the image generation model, the denoising based on the fused action text encoding vector is implemented by using an action editing model, and the action editing model comprises the image generation model and a plurality of image information networks; and
the method further comprises:
performing forward propagation in the action editing model on the noisy image encoding vector and an action text encoding vector to obtain a third action image, the action text encoding vector being the first action text encoding vector or the fused action text encoding vector; and
updating the plurality of image information networks in the action editing model based on a difference between the third action image and the object image to obtain an updated action editing model.

11. The method according to claim 10, wherein the image generation model comprises N cascaded denoising networks and a decoding network, a value of N is greater than or equal to 2, the action editing model is obtained by configuring, based on the image generation model, an image information network for each denoising network, each denoising network and the corresponding image information network form a fusion denoising network, and a cascade relationship between a plurality of fusion denoising networks is the same as a cascade relationship between the plurality of denoising networks; and
the performing forward propagation in the action editing model on the noisy image encoding vector and an action text encoding vector to obtain a third action image comprises:
performing fusion denoising on an input of an n^{th} fusion denoising network by using the n^{th} fusion denoising network among N cascaded fusion denoising networks, and transmitting an n^{th} fusion denoising result output by the n^{th} fusion denoising network to an (n+1)^{th} fusion denoising network for subsequent fusion denoising to obtain an (n+1)^{th} fusion denoising result corresponding to the (n+1)^{th} fusion denoising network, n being an integer between 1 and N−1; and
decoding a fusion denoising result output by an N^{th} fusion denoising network to obtain the third action image,
n having a value increases incrementally by 1, in response to the value of n being 1, the input of the n^{th} fusion denoising network being the noisy image encoding vector and the action text encoding vector, and in response to the value range of n being 2≤n<N, the input of the n^{th} fusion denoising network being an (n−1)^{th} fusion denoising result output by an (n−1)^{th} fusion denoising network and the action text encoding vector.

12. The method according to claim 11, wherein the n^{th} fusion denoising network comprises a plurality of downsampling networks, a plurality of upsampling networks, and an n^{th} image information network corresponding to the n^{th} denoising network; and
the performing fusion denoising on an input of an n^{th} fusion denoising network by using the n^{th} fusion denoising network among N cascaded fusion denoising networks comprises:
performing bypass control on the noisy image encoding vector and the action text encoding vector by using the n^{th} image information network to obtain a bypass control result;
performing downsampling on the action text encoding vector and the bypass control result by using the downsampling network to obtain a downsampling result; and
performing upsampling on the downsampling result by using the upsampling network to obtain the n^{th} fusion denoising result.

13. The method according to claim 12, wherein the n^{th} image information network comprises P cascaded attention layers, and a value of P is greater than or equal to 2; and
the performing bypass control on the noisy image encoding vector and the action text encoding vector by using the n^{th} image information network to obtain a bypass control result comprises:
transmitting a p^{th} attention result of a p^{th} attention layer in the n^{th} image information network to a (p+1)^{th} attention layer for subsequent second attention processing to obtain a (p+1)^{th} attention result of the (p+1)^{th} attention layer in the n^{th} image information network; and
using a second attention result output by each attention layer as the bypass control result,
p being an integer variable whose value increases incrementally starting from 1, a value range of p being 1≤p≤P−1, in response to the value of p being 1, an input of the p^{th} attention layer being the (n−1)^{th} fusion denoising result, and in response to the value range of p being 2≤p<P, the input of the p^{th} attention layer being a (p−1)^{th} attention result output by a (p−1)^{th} attention layer in the n^{th} image information network.

14. The method according to claim 12, wherein the downsampling network comprises P cascaded attention layers; and
the performing downsampling on the action text encoding vector and the bypass control result by using the downsampling network to obtain a downsampling result comprises:
performing first attention processing on an input of a p^{th} attention layer and the action text encoding vector by using the p^{th} attention layer in the downsampling network to obtain a first attention feature;
performing fusion processing on the first attention feature and the p^{th} attention result output by the p^{th} attention layer in the n^{th} image information network to obtain a p^{th} attention result of the p^{th} attention layer in the downsampling network;
transmitting the p^{th} attention result of the p^{th} attention layer in the downsampling network to a (p+1)^{th} attention layer in the downsampling network to obtain a (p+1)^{th} attention result of the (p+1)^{th} attention layer in the downsampling network; and
using a p^{th} attention result output by a p^{th} attention layer in the downsampling network as the downsampling result,
p being an integer variable whose value increases incrementally starting from 1, a value range of p being 1≤p≤P−1, when the value of p is 1, the input of the p^{th} attention layer being the (n−1)^{th} fusion denoising result, and when the value range of p is 2≤p<P, the input of the p^{th} attention layer being a (p−1)^{th} attention result output by a (p−1)^{th} attention layer.

15. The method according to claim 10, further comprising:
obtaining an image editing request, the image editing request comprising one of t: an image rendering request or an action editing request; and
invoking, in response to the image editing request being an image rendering request, an image rendering model to perform image rendering on the object image carried in the image editing request to obtain a rendered image; or
invoking, in response to the image editing request being an action editing request, the action editing model to process the object image carried in the image editing request to obtain the second action image.

16. The method according to claim 1, further comprising:
displaying an image editing entry;
displaying, in response to an information input operation at the image editing entry, input image editing information, the image editing information comprising a basic image and editing information, the editing information comprising at least one of an editing text or a guide image, the editing text being the action instruction text or a rendering text, and the guide image and the rendering text both representing a rendering direction; and
displaying, in response to an image processing operation based on the image editing information in response to the editing text being the action instruction text, a target image obtained by editing the basic image based on the editing information, the basic image being applied as the object image, and the target image being obtained from the second action image.

17. An artificial intelligence-based image processing apparatus, comprising:
at least one memory, configured to store computer-executable instructions; and
at least one processor, configured to, when executing the computer-executable instructions stored in the at least one memory, implement:
performing noise addition on an object image to obtain a noisy image encoding vector;
performing text encoding on an action instruction text to obtain a first action text encoding vector;
denoising the noisy image encoding vector based on the first action text encoding vector to obtain a first action image, the denoising based on the first action text encoding vector being performed iteratively, a denoising result of a current round of the denoising being an input of a next round of the denoising, and the first action image being obtained by decoding a denoising result of a final round of the denoising;
updating the first action text encoding vector based on a difference between the first action image and the object image to obtain a second action text encoding vector;
performing fusion processing on the first action text encoding vector and the second action text encoding vector to obtain a fused action text encoding vector; and
denoising the noisy image encoding vector based on the fused action text encoding vector to obtain a second action image, the second action image being a result of applying an action corresponding to the action instruction text to an object comprised in the object image.

18. The apparatus according to claim 17, wherein the text encoding is implemented by invoking a text model in a text-image contrastive model, and the at least one processor is further configured to implement:
obtaining a plurality of first text samples and first image samples respectively matching the first text samples;
performing image encoding on each first image sample by using a visual model of the text-image contrastive model to obtain an image encoding vector of each first image sample;
performing text encoding on each first text sample by using the text model of the text-image contrastive model to obtain a text encoding vector of each first text sample;
determining a text-image contrastive loss based on the text encoding vector of each first text sample, the image encoding vector of each first image sample, and a matching relationship between each first text sample and each first image sample; and
updating a parameter of the text-image contrastive model based on the text-image contrastive loss.

19. The apparatus according to claim 17, wherein the performing noise addition on an object image to obtain a noisy image encoding vector comprises:
superimposing the object image and a noisy image to obtain a superimposed image; and
performing image latent space encoding on the superimposed image to obtain the noisy image encoding vector.

20. A non-transitory computer-readable storage medium, having computer-executable instructions stored thereon, the computer-executable instructions, when executed by at least one processor, causing the at least one processor to implement:
performing noise addition on an object image to obtain a noisy image encoding vector;
performing text encoding on an action instruction text to obtain a first action text encoding vector;
denoising the noisy image encoding vector based on the first action text encoding vector to obtain a first action image, the denoising based on the first action text encoding vector being performed iteratively, a denoising result of a current round of the denoising being an input of a next round of the denoising, and the first action image being obtained by decoding a denoising result of a final round of the denoising;
updating the first action text encoding vector based on a difference between the first action image and the object image to obtain a second action text encoding vector;
performing fusion processing on the first action text encoding vector and the second action text encoding vector to obtain a fused action text encoding vector; and
denoising the noisy image encoding vector based on the fused action text encoding vector to obtain a second action image, the second action image being a result of applying an action corresponding to the action instruction text to an object comprised in the object image.
